(19) United States
(12) Patent Application Publication
(10) Pub. No.: US 2008/0005207 A1
(43) Pub. Date: Jan. 3, 2008

(54) Image processing apparatus, storage medium and data signal

(75) Inventors: Yukio Kumazawa, Kanagawa (JP); Takashi Nagao, Kanagawa (JP); Youichi Isaka, Kanagawa (JP); Takashi Igarashi, Tokyo (JP); Yusuke Sugimoto, Tokyo (JP); Kazuyuki Itagaki, Tokyo (JP); Junichi Kaneko, Kanagawa (JP)

Correspondence Address: OLIFF & BERRIDGE, PLC, P.O. BOX 320850, ALEXANDRIA, VA, 22320-4850, US

(73) Assignees: FUJI XEROX CO., LTD., TOKYO (JP); FUJIFILM CORPORATION, TOKYO (JP)

(21) Appl. No.: 11/637,726

(22) Filed: Dec. 13, 2006

(30) Foreign Application Priority Data
Jun. 29, 2006 (JP) 2006-179257

(51) Int. Cl. G06F 17/30

(52) U.S. Cl. 707/205

(57) ABSTRACT

An image processing apparatus has an image processing section having modules and a storage resource management unit. The storage resource management unit determines whether or not a necessary capacity of a storage resource is equal to or less than a remaining amount of a memory when a module needs to be allocated with the storage resource, allocates the secured memory as the storage resource to the module when the capacity is equal to or less than the remaining amount or, when the capacity is larger than the remaining amount, secures a storage region of an external storage apparatus and allocates the storage region as the storage resource, or writes data written in a memory allocated to another module in the storage region and allocates the memory previously allocated to the other module as the storage resource to the module.

### BACKGROUND

1. Technical Field

The present invention relates to an image processing apparatus, a storage medium and a data signal, and more particularly to an image processing apparatus provided with an image processing section in which individual modules are coupled in a pipe line aspect or a directed acyclic graph aspect in such a manner that buffer modules are respectively coupled to at least one of preceding stages or following stages of plural image processing modules, a storage medium for storing an image processing program for making a computer execute an image processing, and a computer data signal corresponding to a carrier wave.

2. Related Art

In an image processing apparatus executing an image processing to an input image data, a desk top publishing (DTP) system capable of treating an image, a print system recording an image expressed by the input image data in a recording material and the like, various image processing such as a scaling, a rotation, an affine transformation, a color transformation, a filter processing, an image combine and the like are executed to the input image data. In these apparatuses and systems, in the case that the attribute of the input image, and the contents, the procedures, the parameters or the like of the image processing with respect to the image data are fixed, there is a case that the image processing is executed by an exclusively designed hardware. However, for example, in the case that various image data having different color spaces and different bit numbers per one pixel are input, or the contents, the procedures, the parameters or the like of the image processing are variously changed, it is necessary to employ a structure which may more flexibly change the image processing to be executed.

### SUMMARY

In consideration of the above circumstances, the present invention provides an image processing apparatus, a storage medium and a data signal.

According to an aspect of the invention, there is provided an image processing apparatus comprising: an image processing section having a plurality of modules constituted by a plurality of image processing modules and a buffer module, the plurality of image processing modules acquiring image data from a preceding module thereof, applying a predetermined image processing to the acquired image data, and outputting processed image data or a result of the image processing to a following module thereof, and the buffer module being connected to at least one of a preceding stage or a following stage of the plurality of image processing modules, and being connected according to a pipe line aspect or a directed acyclic graph aspect so as to allow writing of the image data output from the preceding module in a buffer and reading of the image data stored in the buffer by the following module; and a storage resource management unit that determines whether or not a capacity of a storage resource necessary for allocation is equal to or less than a remaining amount of a securable memory when a module needs to be allocated with the storage resource, or secures the memory and allocates the secured memory as the storage resource to the module that needs to be allocated with the storage resource when the capacity of the storage resource necessary for allocation is equal to or less than the remaining amount, or secures a storage region of an external storage apparatus so as to allocate the secured storage region of the external storage apparatus as the storage resource to the module that needs to be allocated with the storage resource, or secures the storage region of the external storage apparatus so as to write data written in a memory which has already been allocated to another module as the storage resource in the secured storage region of the external storage apparatus and allocate the storage region of the external storage apparatus in which the data is written to the other module in place of the memory in which the data had been written and allocates the memory which had been allocated to the other module as the storage resource to the module that needs to be allocated with the storage resource, when the capacity of the storage resource necessary for allocation is larger than the remaining amount.

### BRIEF DESCRIPTION OF THE DRAWINGS

Exemplary embodiments of the present invention will be described in detail on the following figures, wherein:

FIG. 1 is a block diagram showing a schematical structure of a computer (an image processing apparatus) according to the exemplary embodiment;

FIGS. 2A to 2C are block diagram showing an example of a structure of an image processing section;

FIGS. 3A and 3B are block diagrams respectively showing schematical structures and executed processes of an image processing module and a buffer module;

FIG. 4 is a flowchart showing contents of a data writing process executed by the buffer module;

FIGS. 5A to 5C are schematic views explaining a case that an image data to be written strides over plural storing unit buffer regions;

FIG. 6 is a flowchart showing contents of a data reading process executed by the buffer module;

FIGS. 7A to 7C are schematic views explaining a case that an image data to be read strides over the plural storing unit buffer regions;

FIG. 8 is a flowchart showing contents of an image processing module control process executed by a controller of the image processing module;

FIGS. 9A to 9D are flowcharts showing contents of a parallel control process executed by a workflow management section;

FIG. 10 is a schematic view explaining a flow of an image processing in an image processing section;

FIG. 11 is a flowchart showing contents of a storage resource acquiring request time process executed by a resource management section;

FIG. 12 is a flowchart showing contents of a storage resource release request time process executed by the resource management section;

FIGS. 13A to 13D are flowcharts showing contents of a parallel control process executed by a workflow management section according to a second exemplary embodiment;

FIGS. 14A to 14E are schematic views showing an example of a transition of a thread execution priority in correspondence to individual image processing modules according to a series of image processing in the image processing section;

FIGS. 15A and 15B are block diagrams for explaining a definition of a position of the image processing module in a coupling aspect of a pipe line aspect or a directed acyclic graph aspect;

FIG. 16 is a flowchart showing contents of a storage resource acquiring request time process executed by a resource management section according to the second exemplary embodiment; and

FIG. 17 is a flowchart showing contents of a storage resource release request time process executed by the resource management section according to the second exemplary embodiment.

### DETAILED DESCRIPTION

A description will be in detail given below of an example of an exemplary embodiment according to the present invention with reference to the accompanying drawings.

### First Exemplary Embodiment

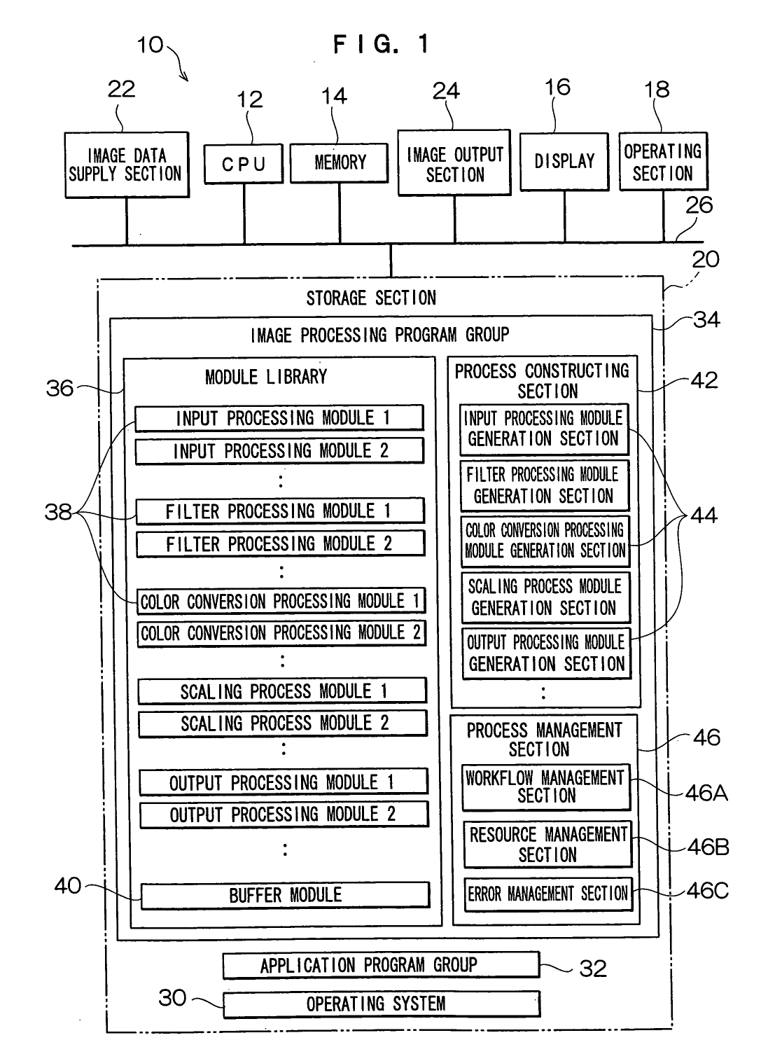

In FIG. 1, there is shown a computer 10 which may function as an image processing apparatus according to the invention. In this configuration, the computer 10 may be incorporated in an optional image treatment equipment which is necessary to executed an image processing in an inner section thereof, such as a copying machine, a printer, a facsimile apparatus, a complex machine having these functions, a scanner, a photo printer or the like, or may be constituted by an independent computer such as a personal computer (PC) or the like. Further, it may be constituted by a computer incorporated in a portable equipment such as a personal digital assistant (PDA), a cellular phone or the like.

The computer 10 is provided with a CPU 12, a memory 14 constituted by DRAM, SRAM or the like, a display 16, an operating section 18, a storage section 20, an image data supply section 22 and an image output section 24, and these elements are connected to each other via a bus 26. In the case that the computer 10 is installed in the image treatment equipment as mentioned above, the display 16 and the operating section 18 may employ a display panel provided in the image treatment equipment and constituted by LCD or the like, a 10-key keyboard or the like. Further, in the case that the computer 10 is constituted by the independent computer, the display 16 and the operating section 18 may employ a display, a keyboard, a mouse or the like connected to the computer. Further, a hard disc drive (HDD) is preferably employed as the storage section 20, however, the storage section 20 may employ the other non-volatile memories such as a flash memory or the like in place of the HDD.

Further, it is sufficient that the image data supply section 22 may supply an image date of a processed object, and may employ, for example, an image reading section reading an image recorded in a recording material such as a paper, a photograph, a film or the like so as to output the image data, a receiving section receiving the image data from an external section via a communication line, an image storage section (the memory 14 or the storage section 20) storing the image data, or the like. Further, it is sufficient that the image output section 24 may output the image data passing through the image processing or the image expressed by the image data, and may employ, for example, an image recording section recording the image expressed by the image data on a recording material such as a paper, a photosensitive material or the like, a display displaying the image expressed by the image data on a display or the like, a writing apparatus writing the image data in a storage media, and a transmitting section transmitting the image data via the communication line. Further, the image output section 24 may be constituted by an image storage section (the memory 14 or the storage section 20) simply storing the image data via the image processing.

As shown in FIG. 1, in the storage section 20, as various programs executed by the CPU 12, there is stored each of a program of an operating system 30 controlling a management of the resources such as the memory 14 or the like, a management of an execution of the program by the CPU 12, a communication between the computer 10 and the external section, or the like, an image processing program group 34 for making the computer 10 function as the image processing apparatus according to the invention, and programs of various applications 32 (expressed as an application program group 32 in FIG. 1) making the image processing apparatus achieved by executing the image processing program group by the CPU 12 execute a desired image processing.

The image processing program group 34 is constituted by a program developed so as to be commonly usable for various equipments (platforms) such as the various image treatment equipments, the cellular phone, the PC or the like for the purpose of reducing a development load at a time of developing the various image treatment equipments and the cellular phone mentioned above, and reducing a development load at a tie of developing the image processing program usable in the PC or the like, and corresponds to the image processing program according to the invention. The image processing apparatus achieved by the image processing program group 34 constructs the image processing section executing the image processing instructed by the application 32 according to a constructing instruction from the application 32, and executes the image processing by the image processing section according to an execution instruction from the application 32 (details of which are mentioned below), however, the image processing program group 34 provides an interface for instructing a construction of the image processing section (an image processing section having a desired structure) executing a desired image processing and instructing an execution of the image processing by the constructed image processing section. Accordingly, even in the case of newly developing an optional equipment which is necessary to execute the image processing in an internal section, the development of the program of executing the image processing may be achieved only by developing the application 32 making the image processing program group 34 execute the image processing required for the equipment by utilizing the interface mentioned above, and it is not necessary to newly develop a program of actually executing the image processing. Therefore, the development load may be reduced.

Further, the image processing apparatus achieved by the image processing program group 34 constructs the image processing section executing the image processing instructed by the application 32 according to the constructing instruction from the application 32, and executes the image processing by the constructed image processing section, as mentioned above. Accordingly, for example, even in the case that a color space of the image data of the image processed object or a bit number per one pixel is indefinite, or contents, a procedure, a parameter or the like of the image processing to be executed is indefinite, the application 32 instructs a reconstruction of the image processing section, whereby the image processing executed by the image processing apparatus (the image processing section) may be flexibly changed in correspondence to the image data of the processed object or the like.

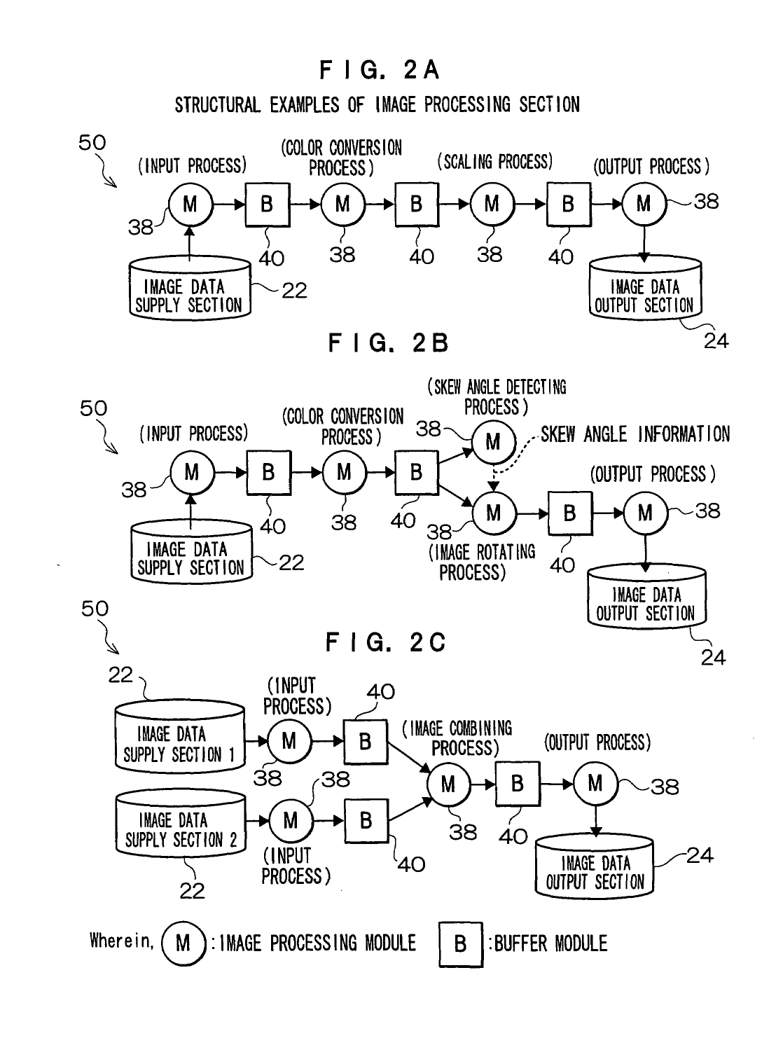

A description will be given below of the image processing program group 34. As shown in FIG. 1, the image processing program group 34 is roughly classified into a module library 36, a program of a processing construction section 42, and a program of a processing management section 46. Although details will be described later, the processing construction section 42 according to the exemplary embodiment constructs an image processing section 50 formed by coupling one or more image processing module 38 executing a predetermined image processing, and a buffer module 40 arranged in at least one of a preceding stage or a following stage of the individual image processing module 38 and provided with a buffer for storing the image data according to a pipe line aspect or a directed acyclic graph (DAG) aspect on the basis of the instruction from the application, as exemplified in FIG. 2. A substance of the individual image processing module constructing the image processing section 50 is constituted by a first program for being executed by the CPU 12 and making the CPU 12 execute a predetermined image processing, or a second program for being executed by the CPU 12 and making the CPU 12 instruct an execution of the process applied to the external image processing apparatus (for example, a special image processing board or the like) which is not illustrated in FIG. 1, and each of programs of plural kinds of image processing modules 38 is registered in the module library 36 mentioned above, the image processing modules 38 executing predetermined different image processing (for example, an input process, a filter process, a color change process, a scaling process, a skew angle detecting process, an image rotating process, an image combining process, an output process or the like). In the following description, in order to make the description simple, a description will be given on the assumption that the substance of the individual image processing module constructing the image processing section 50 is constituted by the first program mentioned above.

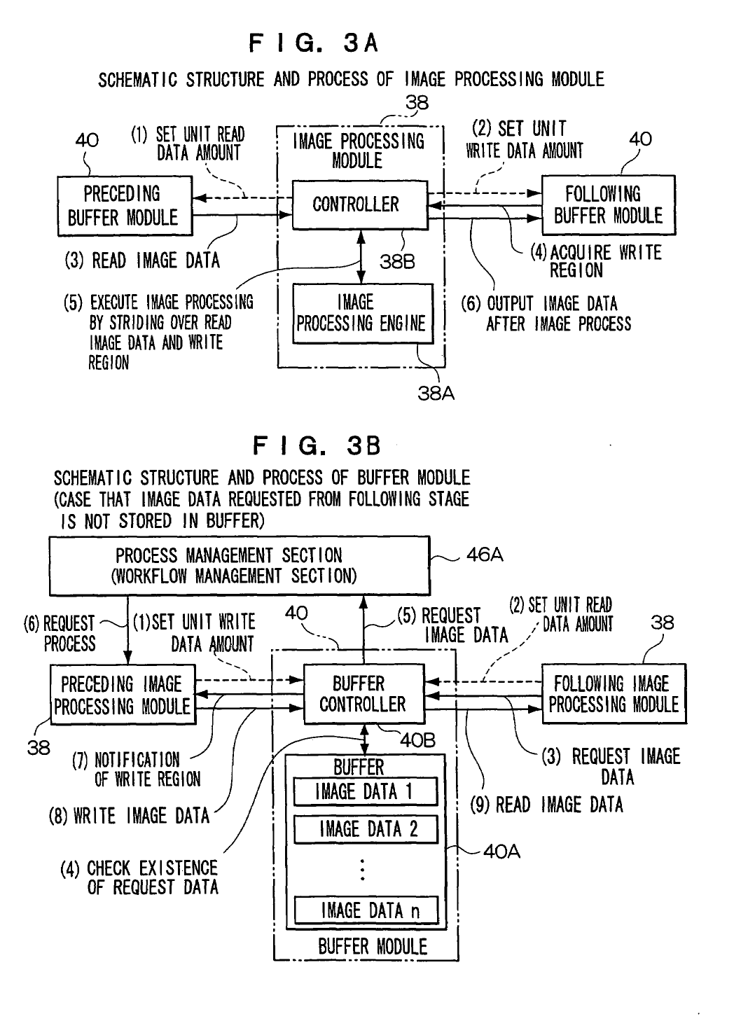

The individual image processing module 38 is constituted by an image processing engine 38A executing an image processing with respect to the image data in increments of a predetermined unit processing data amount, and a controller 38B executing input and output of the image data with respect to the preceding and following modules of the image processing module 38 and a control of the image processing engine 38A, as shown in FIG. 3A as an example. The unit processing data amount in the individual image processing module 38 is previously selected and set in correspondence to the kind of the image processing executed by the image processing engine 38A or the like, among optional bite numbers including one line part of the image, plural lines part of the image, one pixel part of the image, one surface part of the image or the like. For example, the unit processing data amount is set to one pixel part in the image processing module 38 executing the color change process or the filter process, the unit processing data amount is set to one line part of the image or the plural lines part of the image in the image processing module 38 executing the scaling process, the unit processing data amount is set to one surface part of the image in the image processing module 38 executing the image rotating process, and the unit processing data amount is set to an N bite depending on an execution environment in the image processing module 38 executing the image scaling process.

Further, in the module library 36, there is also registered the image processing module 38 in which the kind of the image processing executed by the image processing engine 38A is identical and the contents of the executed image processing is different (this kind of image processing module is expressed by “module 1” and “module 2” in FIG. 1). For example, with respect to the image processing module 38 executing the scaling process, there are prepared plural image processing modules 38 such as an image processing module 38 executing a contracting process of contracting the image into 50% by thinning the input image data at intervals of one pixel, an image processing module 38 executing the scaling process at designated enlargement ratio and reduction ratio with respect to the input image data, or the like. Further, for example, with respect to the image processing module 38 executing the color change process, there are respectively prepared an image processing module 38 changing an RGB color space to a CMY color space, an image processing module 38 changing inversely, and an image processing module 38 executing the other color space change such as L*a*b* color space or the like.

Further, the controller 38B of the image processing module 38 executes a process of acquiring the image data in increments of the unit read data amount from the preceding module (for example, the buffer module 40) of its module, and outputting the image data output from the image processing engine 38A to the following module (for example, the buffer module 40) in increments of the unit write data (if the image processing accompanying increase and decrease of the data amount such as the compression or the like is not executed by the image processing engine 38A, a relation of unit write data amount=unit processing data amount is established), or outputting a result of the image processing by the image processing engine 38A to an external section of the self module (for example, in the case that the image processing engine 38A executes the image analysis process such as the skew angle detection process or the like, the image analysis process result such as the skew angle detection result or the like may be output in place of the image data), in order to input the image data necessary for processing the data in increments of the unit processing data amount by the image processing engine 38A. In the module library 36, there is also registered an image processing module 38 in which the kind and the contents of the image processing executed by the image processing engine 38A are identical, and the unit processing data amount, the unit read data amount and the unit write data amount are different. For example, the unit processing data amount in the image processing module 38 executing the image rotating process is not limited to one surface part of the image mentioned above, but plural image processing modules 38 executing the same image rotation process and having the different unit processing data amount (for example, one line part, plural lines part or the like of the image) may be included in the module library 36.

Further, the program of the individual image processing module 38 to be registered in the module library 36 is constituted by the program corresponding to the image processing engine 38A and the program corresponding to the controller 38B, however, the program corresponding to the controller 38B is made into parts, and in the image processing module 38 having the same unit read data amount and unit write data amount in the individual image processing module 38, the program corresponding to the controller 38B is made in common in spite of the kind and the contents of the image processing executing by the image processing engine 38A (the same program is used as the program corresponding to the controller 38B). Accordingly, the developing load for developing the program of the image processing module 38 is reduced.

In this configuration, the unit read data amount and the unit write data amount are not defined in the image processing module 38 under a state in which the attribute of the input image is unknown, and there exists a module by which the unit read data amount and the unit write data amount are defined by acquiring the attribute of the input image data and substituting the acquired attribute for a predetermined arithmetic expression so as to compute. However, in this kind of image processing module 38, the program corresponding to the controller 38B may be made in common, with respect to the image processing module 38 in which the unit read data amount and the unit write data amount are derived by using the same arithmetic expression. Further, the image processing program group 34 according to the exemplary embodiment may be mounted to the various equipments as mentioned above, however, it goes without saying that the number, the kind or the like of the image processing module 38 registered in the module library 36 among the image processing program group 34 may be appropriately added, deleted, replaced or the like in correspondence to the image processing necessary for the various equipment mounting the image processing program group 34 therein.

Further, the individual buffer module 40 constituting the image processing section 50 is constituted by a buffer 40A, and a buffer controller 40B executing input and output of the image data with respect to the preceding stage and the following stage of the buffer module 40 and a management of the buffer 40A, as shown in FIG. 3B as an example. In this configuration, the buffer 40A is constituted by a memory region secured through the operating system 30 and the resource management section 46B from the memory 14 provided in the computer 10, however, in the case that the memory 14 comes short at a time of generating the buffer module 40, a storage region of the storage section 20 is secured in place of the resource management section 46B, and the secured storage region of the storage section 20 is substituted (details of a process by the resource management section 46B will be described later). The buffer controller 40B of the individual buffer module 40 is constituted by the program executed by the CPU 12 in its substance, and the program of the buffer controller 40B is registered in the module library 36 (the program of the buffer controller 40B is expressed as “buffer module” in FIG. 1).

Further, the process constructing section 42 constructing the image processing section 50 according to the instruction from the application 32 is constituted by plural kinds of module generation sections 44 as shown in FIG. 1. The plural kinds of module generation sections 44 correspond to the different image processing from each other, and execute a process of generating the module group constituted by the image processing module 38 and the buffer module 40 for achieving the corresponding image processing, by being activated by the application 32. In this configuration, in FIG. 1, there is shown the module generation section 44 corresponding to the kind of the image processing executed by the individual image processing module 38 registered in the module library 36, as an example of the module generation section 44, however, the image processing corresponding to the individual module generation section 44 may be constituted by an image processing (for example, a skew correction process constituted by a skew angle detection process and an image rotation process) achieved by the plural kinds of image processing modules 38. In the case that the required image processing is constituted by a process obtained by combining the plural kinds of image processing, the application 32 sequentially activates the module generation section 44 corresponding to any one of the plural kinds of image processing. Accordingly, the image processing section 50 executing the necessary image processing is constructed by the module generation section 44 sequentially activated by the application 32.

Further, as shown in FIG. 1, the process management section 46 is structured such as to include a workflow management section 46A controlling the execution of the image processing in the image processing section 50, a resource management section 46B managing the use of the resource of the computer 10 such as the memory 14, the various files or the like by each of the modules of the image processing section 50, and an error management section 46C managing an error generated in the image processing section 50. In this configuration, in the exemplary embodiment, the image processing section 50 constructed by the process construction section 42 is actuated in such a manner that the individual image processing module 38 constructing the image processing section 50 executes the image processing in parallel while the image data is delivered to the following stage according to a unit of the data amount smaller than one surface part of the image.

In this configuration, the error management section 46C acquires an error information such as a kind, a generated position or the like of the generated error in the case that the error is generated in the process that the image processing section 50 executes the image processing. Further, the error management section 46C acquires an apparatus environment information expressing a kind, a structure or the like of the equipment incorporating the computer 10 in which the image processing program group 34 is installed, from the storage section 20 or the like, determines an error informing method in correspondence to the apparatus environment expressed by the acquired apparatus environment information, and executes a process of informing the error generation according to the determined error informing method.

Next, a description will be given of an action of the exemplary embodiment. In the equipment in which the image processing program group 34 is mounted, if a condition in which it is necessary to execute any image processing is generated, the condition is detected by the specific application 32. In this configuration, as the condition in which it is necessary to execute the image processing, there may be listed up, for example, a case that a user instructs an execution of a job of reading the image by the image reading section serving as the image data supply section 22 so as to record as the image in the recording material by the image recording section serving as the image output section 24, record as the image in the recording material by the image recording section serving as the image output section 24, display as the image on the display serving as the image output section 24, write the image data on the recording media by the writing apparatus serving as the image output section 24, transmit the image data by the transmission section serving as the image output section 24, or store in the image recording section serving as the image output section 24, or a case that a user instructs an execution of a job executing any one of the recording on the recording material mentioned above, the display on the display, the writing and the transmission to the recording media, and the storage in the image recording section, with respect to the image data received by the receiving section serving as the image data supply section 22, or stored in the image storage section serving as the image data supply section 22. Further, the condition that it is necessary to execute the image processing is not limited to the condition mentioned above, but may include, for example, a case that a process of an executed object is selected by the user under a state in which a name or the like of the process that the application 32 may execute in correspondence to the instruction from the user on the display 16 as a list.

As mentioned above, if the condition that it is necessary to execute any image processing is detected, the application 32 first recognizes the kind of the image data supply section 22 supplying the image data of the image processed object. In the case that the recognized kind exists in the buffer region (a partial region of the memory 14 or the storage section 20), the application 32 sets a parameter making the buffer controller 40B recognize the buffer region designated as the image data supply section 22 as the already secured buffer 40A, and generates a thread executing the program of the buffer controller 40B (generates the buffer controller 40B), thereby generating the buffer module 40 (the buffer module 40 serving as the image data supply section 22) including the designated buffer region. Further, the buffer module 40 may be generated as a process or an object in place of the thread.

Subsequently, the application 32 recognizes the kind of the image output section 24 serving as an output destination of the image data executing the image processing, in the same manner. In the case that the recognized kind exists in the buffer region (the partial region of the memory 14 or the storage section 20), the application 32 generates the buffer module 40 including the buffer region designated as the image output section 24 in the same manner as mentioned above. The buffer module 40 generated here functions as the image output section 24. Further, the application 32 recognizes the contents of the image processing to be executed, dissembles the image processing to be executed into a combination of the image processing in a level corresponding to the individual module generation section 44, and judges the kind of the image processing necessary for achieving the image processing to be executed, and an executing order of the individual image processing. In this configuration, this judgment may be achieved, for example, by previously registering the kind of the image processing mentioned above and the executing order of the individual image processing as information in correspondence to the kind of the job that the user may instruct its execution, and executing the process of reading the corresponding information to the kind of the job instructed to be executed by the application 32.

Further, the application 32 starts the module generation section 44 corresponding to the specific image processing (generates the process, the thread or the object executing the program of the module generation section 44), on the basis of the kind and the executing order of the image processing judged as mentioned above, and thereafter informs the activated module generation section 44 of an input module identification information for identifying an input module inputting the image data to the module group, an output module identification information for identifying an output module to which the module group outputs the image data, an input image attribute information expressing an attribute of the input image data input to the module group, and a parameter of the image processing to be executed as the information necessary for generating the module group by the module generation section 44, so as to instruct the generation of the corresponding module group. Further, in the case that the necessary image processing is constituted by a process obtained by combining the plural kinds of image processings, the application 32 activates the other module generation sections 44 corresponding to the individual image processing so as to repeat the process of informing of the information necessary for generating the module group in the ascending order of the execution of the individual image processing, if the completion of the generation of the module group is informed from the instructing module generation section 44.

In this configuration, the input module mentioned above is structured such that the image data supply section 22 serves as the input module in the module group that an execution sequence is the first, and the final module (normally the buffer module 40) in the preceding stage module group serves as the input module in the module group that the execution sequence is the second or later. Further, with respect to the output module mentioned above, since the image output section 24 serves as the output module in the module group that the execution sequence if the last, the image output section 24 is designated as the output module, however, with respect to the other module groups, since the output module is indefinite, the designation by the application 32 is not executed, but the output module is generated and set by the module generation section 44 in case of necessity. Further, with respect to the input image attribute and the parameter of the image processing, they may be recognized by the application 32, for example, by being previously registered as the information in correspondence to the kind of the job that the user may instruct the execution thereof, and reading the information corresponding to the kind of the job instructed to be executed, or may be designated by the user.

On the other hand, if the module generation section 44 is activated by the application 32, the module generation section 44 executes the module generation process. In the module generation process, there is first acquired an input image attribute information expressing an attribute of the input image data input to the image processing module 38 corresponding to the generation object. In this configuration, in the case that the buffer module 40 exists in the preceding stage of the image processing module 38 corresponding to the generated object, the process of acquiring the attribute of the input image data may be achieved by acquiring the attribute of the output image data from the further preceding image processing module 38 executing the writing of the image data on the buffer module 40.

Further, it judges on the basis of the attribute of the input image data expressed by the acquired information whether or not the image processing module 38 corresponding to the generated object is necessary. For example, in the case that the module generation section 44 is constituted by the module generation section generating the module group executing the color change process, and the CMY color space is designated as the color space of the output image data from the application 32 on the basis of the parameter of the image processing, if it is identified that the input image data is constituted by the data of the RGB color space on the basis of the acquired input image attribute information, it is necessary to generate the image processing module 38 executing the color space change from RGB to CMY as the image processing module 38 executing the color space process, however, if the input image data is constituted by the data of the CMY color space, the attribute of the input image data coincides with the attribute of the output image data in connection with the color space, and it is determined that it is not necessary to generate the image processing module 38 executing the color space change process.

In the case that it is determined that it is necessary to generate the image processing module 38 corresponding to the generated object, it is judged whether or not the buffer module 40 is necessary in the following stage of the image processing module 38 corresponding to the generated object. This judgment is denied in the case that the following stage of the image processing module is constituted by the output module (the image output section 24) (refer, for example, to the image processing module 38 in the final stage in the image processing section 50 shown in FIGS. 2A to 2C), or in the case that the image processing module is constituted by the module applying the image processing such as the analysis or the like to the image data and outputting the results thereof to the other image processing module 38, such as the image processing module 38 executing the skew angle detecting process in the image processing section 50 shown in FIG. 2B as an example. However, in the cases other than the above, the judgment is affirmed so as to activate the buffer controller 40B (generate each of the threads executing the programs of the buffer controller 40B), thereby generating the buffer module 40 coupled to the following stage of the image processing module 38. In this configuration, the buffer module 40 may be generated as a process or an object in place of the thread.

Subsequently, the attribute of the input image data acquired in advance, and the image processing module 38 coinciding with the processing parameter to be executed by the image processing module 38 are selected and generated (the thread executing the programs of the image processing engine 38A and the controller 38B is generated) from plural candidate modules that are registered in the module library 36 and may be utilized as the image processing module 38, by applying the information of the preceding module (for example, the buffer module 40), the information of the following buffer module 40 (only the image processing module 38 generating the following buffer module 40), the attribute of the input image data input to the image processing module 38, and the processing parameter. In this configuration, the image processing module 38 may be generated as a process or the object in place of the thread.

For example, in the case that the module generation section 44 is constituted by the module generation section generating the module group executing the color change process, the CMY cooler space is designated as the cooler space of the output image data by the processing parameter, and the input image data is constituted by the data of the RGB color space, the image processing module 38 executing the color space change from RGB to CMY is selected and generated among plural kinds of image processing modules 38 executing various color space processes registered in the module library 36. Further, if the image processing module is constituted by the image processing module 38 executing the scaling process, and the designated scaling ratio is the other than 50%, the image processing module 38 executing the scaling process is selected and generated at the designated scaling ratio with respect to the input image data, and if the designated scaling ratio is 50%, the image processing module 38 executing the contracting process of contracting to 50% is selected and generated by executing the scaling process that the scaling ratio is specified to 50%, that is, by thinning the input image data at intervals of 1 pixel.

In this configuration, the selection of the image processing module 38 is not limited to the structure mentioned above, but the image processing module 38 may be selected, for example, by registering plural image processing modules 38 having the different unit processing data amounts in the image processing by the image processing engine 38A in the module library 36, and selecting the image processing module 38 having a proper unit processing data amount in correspondence to the operation environment such as the size of the memory region capable of being allocated to the image processing section 50 or the like (for example, selecting the image processing module 38 having the small unit processing data amount in accordance that the size becomes smaller or the like), or may selected by the application 32 or the user.

If the generation of the image processing module 38 is finished, the set of the ID of the following buffer module 40 and the ID of the generated image processing module 38 is notified the workflow management section 46A. It is sufficient that this ID is constituted by the information that may uniquely discriminate the individual module, and may be constituted, for example, by a number applied in the generation order of the individual module, an address on the memory of the object of the buffer module 40 or the image processing module 38, or the like. Further, in the case that the module generation section 44 generates the module group executing the image processing process achieved by the plural kinds of image processing module 38 (for example, the skew correction process achieved by the image processing module 38 executing the skew angle detection process and the image processing module 38 executing the image rotation process), the process mentioned above is repeated and the module group including two or more image processing modules 38 is generated. The module generation processes mentioned above are sequentially executed by the individual module generation section 44 sequentially activated by the application 32, whereby the image processing section 50 executing the necessary image processing is constructed, as shown in FIGS. 2A to 2C as an example.

In this configuration, in the exemplary embodiment, in the case that the execution frequency of the specific image processing is high, the application 32 may regenerate the image processing section 50 executing the specific image processing, by saving as the thread (the process or the object) by not instructing the process end even after generating the image processing section 50 executing the specific image processing, with respect to plural kinds of module generation sections 44 for generating the image processing section 50 executing the specific image processing, and sequentially instructing the generation of the module group with respect to each of the module generation sections 44 saved as the thread. Accordingly, it is not necessary to execute the process of activating each of the corresponding module generation sections 44 each time when the necessity of executing the specific image processing is generated, and a time necessary for regenerating the image processing section 50 executing the specific image processing may be shortened.

In this configuration, if the controller 38B of the image processing module 38 is activated by the module generation section 44, it executes an initialization of the image processing module 38. In this initialization, it first stores the information of the preceding and following modules of the self module applied from the module generation section 44. Subsequently, it judges the module in the preceding stage of the self module. In the case that no module exists in the preceding stage of the self module, no process is executed, however, in the case that the preceding module is constituted by the structures other than the buffer module 40, for example, the image data supply section 22, the specific file or the like, an initialization process thereof is executed as occasion demands. Further, in the case that the buffer module 40 exists in the preceding stage of the self module, it recognizes the data amount (the unit read data amount) of the image data acquired by the reading of the image data at one time from the preceding buffer module 40. In the case that the number of the buffer module 40 in the preceding stage of the self module is one, the number of the unit read data amount is only one, however, in the case that the number of the buffer module 40 in the preceding stage is plural, and the image processing engine 38A executing the image processing by using the image data acquired from the plural buffer modules 40, for example, in the image processing module 38 executing the image combination process in the image processing section 50 shown in FIG. 2C, the unit read data amount corresponding to the individual buffer module 40 in the preceding stage is determined in correspondence to the kind and the content of the image processing executed by the image processing engine 38A of the self module, the number of the buffer module 40 in the preceding stage or the like. Further, the unit read data amount is set in all the buffer modules 40 existing in the preceding stage by notifying all the buffer modules 40 existing in the preceding stage of the recognized unit read data amount (refer also to item (1) in FIG. 3A).

Next, the following module of the self module is judged. In the case that the following module of the self module is constituted by the structures other than the buffer module 40, for example, constituted by the image output section 24, the specific file or the like, it executes the initialization process as occasion demand (for example, the process of notifying of outputting the image data at intervals of the data amount corresponding to the unit write data amount, if the following module is constituted by the image output section 24). Further, in the case that the following module is constituted by the buffer module 40, it recognizes the data amount (the unit write data amount) of the image data in the writing of the image data at one time, and sets the unit write data amount in the following buffer module (refer to item (2) in FIG. 3A). Further, the end of the initialization of the image processing module 38 is informed the module generation section 44, and the process is finished.

On the other hand, if the buffer controller 40B of the individual buffer module 40 constituting the image processing section 50 is activated by the module generation section 44 or the application 32, it executes the initialization of the buffer module 40. In the initialization of the buffer module 40, the notified unit write data amount or unit read data amount is first stored each time when the unit write data amount is notified from the preceding image processing module 38 of the self module or the unit read data amount is notified from the following image processing module 38 of the self module (refer to items (1) and (2) in FIG. 3B).

If the unit write data amount or the unit read data amount is notified from all the image processing modules 38 coupled to the self module, the size of the unit buffer region corresponding to the management unit of the buffer 40A of the self module is determined on the basis of the unit write data amount and the unit read data amount each being set by the individual image processing module 38 coupled to the self module, and the size of the determined unit buffer region is stored. As the size of the unit buffer region, the maximum value of the unit write data amount and the unit read data amount set in the self module is preferable, however, the unit write data amount may be set, or the unit read data amount (the maximum value of the unit read data amount each being set by the individual image processing module 38, in the case that the plural image processing modules 38 are coupled to the following stage of the self module) may be set, or a least common of (the maximum values of) the unit write data amount and the unit read data amount may be set. If the least common is less than a predetermined value, the least common may be set, and if the least common is equal to or more than a predetermined value, the other values (for example, any one of the maximum value of the unit write data amount and the unit read data amount mentioned above, the unit write data amount, and (the maximum value of) the unit read data amount).

Further, in the case that the self module is generated by the application 32, and is constituted by the buffer module 40 serving as the image data supply section 22 or the image output section 24, the region on the memory 14 or the storage section 20 used as the buffer 40A of the self module already exists. The size in the previously determined unit buffer region is changed to the size of the existing region used as the buffer 40A of the self module. Further, a valid data pointer is generated in correspondence to each of the individual image processing modules 38 in the following stage of the self module, and the generated valid data pointer is initialized. The valid data pointers respectively indicate a head position (next read starting position) and an end position of the image data (the valid data) that is not read by the corresponding image processing module 38 in the following stage, in the image data written in the buffer 40A of the self module by the image processing module in the preceding stage of the self module, and the specific information meaning the nonexistence of the valid data is generally set at a time of initializing. However, if the self module is generated by the application 32 and is constituted by the buffer module 40 serving as the image data supply section 22, there is a case that the image data of the image processed object has already written in the region on the memory 14 or the storage section 20 used as the buffer 40A of the self module. In this configuration, the head position and the end position of the image data are respectively set to the valid data pointers corresponding to the individual image processing modules 38 in the following stage. The initialization of the buffer module 40 is finished on the basis of the process mentioned above, and the buffer controller 40B notifies the workflow management section 46A of the end of the initialization.

On the other hand, if the module generation process mentioned above is sequentially executed by the sequentially activated module generation section 44, whereby the constitution of the image processing section 50 executing the necessary image processing is finished, the application 32 activates the thread (or the process or the object) executing the program of the workflow management section 46A, thereby instructing the execution of the image processing by the image processing section 50 to the workflow management section 46A.

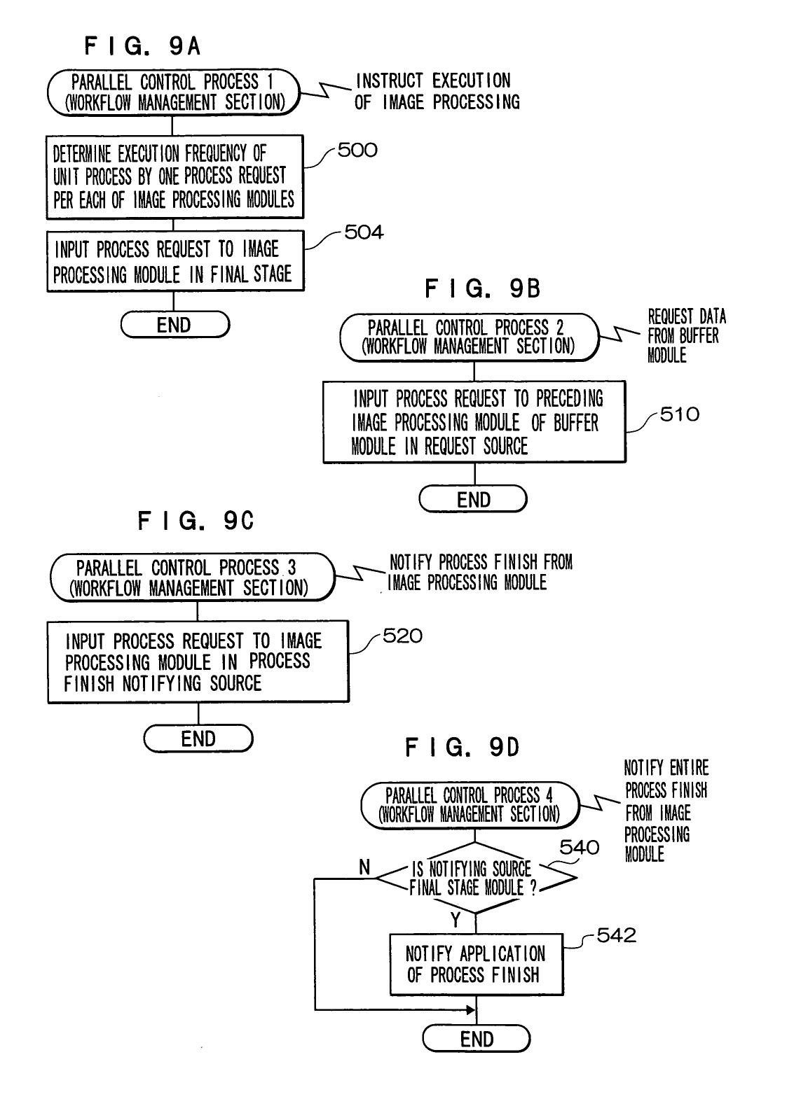

The workflow management section 46A of the process management section 46 executes a parallel control process shown in FIG. 9 on the basis of the activation of the program. The workflow management section 46A inputs the process request to the individual image processing module 38 constituting the image processing section 50 in the parallel control process, thereby executing the image processing by the image processing section 50 in parallel per the unit of the individual image processing module 38. A description will be given below of a process after the finish of the initialization process executed by the buffer controller 40B of the individual buffer module 40, and the image processing module control process executed by the controller 38B of the individual image processing module 38, prior to a description of an operation of an entire of the image processing section 50.

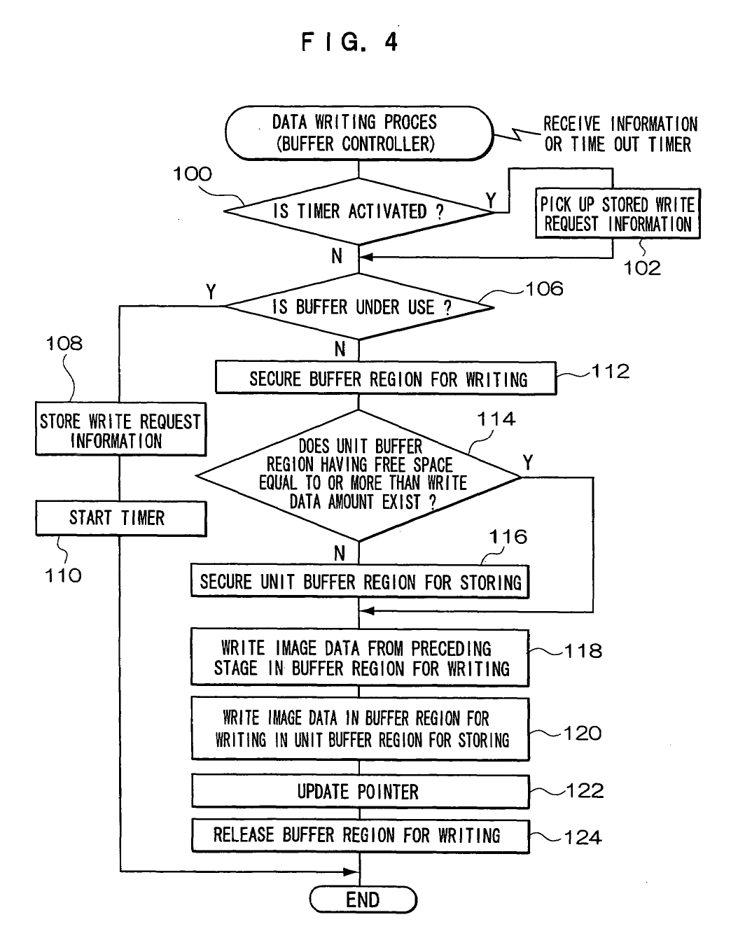

In the exemplary embodiment, in the case that the image processing module 38 writes the image data in the following buffer module 40, the write request is input to the buffer module 40 from the image processing module 38. In the case that the image processing module 38 reads the image data from the preceding buffer module 40, the read request is input to the buffer module 40 from the image processing module 38. In the case that some information including the write request from the preceding image processing module 38 is input to the buffer module 40 (and in the case that a timer mentioned below times out), the data writing process shown in FIG. 4 is executed by the buffer controller 40B. In this configuration, the data writing process described below may be started by calling a function or a method.

In the data writing process, the step judges first in a step 100 whether or not this time data writing process is activated by the time out of the timer. In the case that the judgment is denied, the step goes to a step 106, however, in the case that the judgment is affirmed, the step goes to a step 102, and takes out the write request information input in past and stored in the work memory or the like from the work memory or the like. The step judges in the step 106 whether or not the buffer 40A of the self module is under access. Since the date reading is executed with respect to the buffer 40A, the step goes to a step 108 in the case that the judgment is affirmed, stores the write request information of this time processed object in the work memory or the like, and starts the timer in the next step 110 so as to temporarily finish the data writing process.

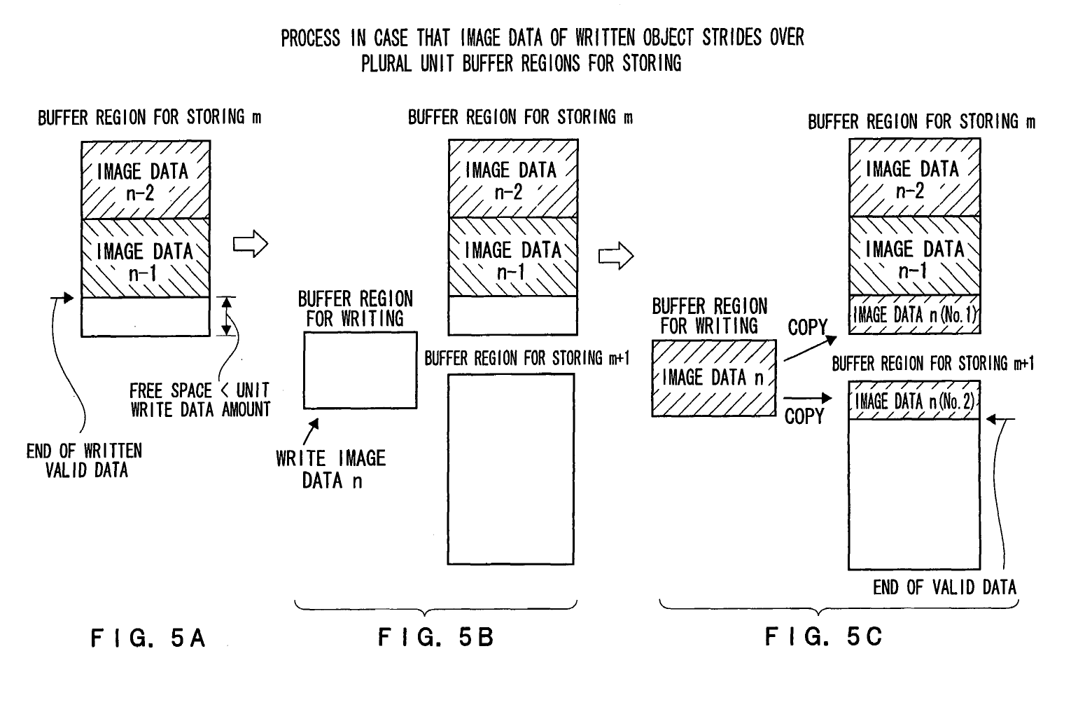

On the other hand, in the case that the judgment in the step 106 is denied, the step goes to a step 112, notifies the resource management section 46B of the unit write data amount as a size of the storage resource to be secured, and secures the storage resource region used for writing (write buffer region: refer also to FIG. 5B) by the resource management section 46B. In this configuration, if the remaining amount of the memory 14 exists, the memory 14 is secured as the storage resource region, however, in the case that the remaining amount of the memory 14 is short, the storage region of the storage section 20 is secured as the storage resource region. In the next step 114, the step judges whether or not a unit buffer region having a free space equal to or more than the unit write data amount (the unit buffer region capable of writing the unit write data amount of image data) exists in the unit buffer region for storage constituting the buffer 40A of the self module.

In the buffer module 40 generated by the module generation section 44, since the storage resource region (the unit buffer region) used as the buffer 40A is not initially secured, but is secured in units of the unit buffer region each time when the short of the storage resource region is generated, the storage resource region (the unit buffer region) used as the buffer 40A does not exist at a time when the write request is first input to the buffer module 40, and the judgment is denied. Further, even after the unit buffer region used as the buffer 40A is secured via the process mentioned below, the judgment mentioned above is denied also in the case that the free space within the unit buffer region becomes less than the unit write data amount according to the writing of the image data in the unit buffer region.

In the case that the judgment in the step 114 is denied, the step goes to a step 116, and informs the resource management section 46B of the size of the storage resource to be secured (the size of the unit buffer region), and the step goes to a step 118 after securing the storage resource region (the unit buffer region used for storing the image data) used as the buffer 40A of the self module by the resource management section 46B. In this configuration, if the remaining amount of the memory 14 exists, the memory 14 is secured as the storage resource region at this time, however, in the case that the remaining amount of the memory 14 is short, the storage region of the storage section 20 is secured as the storage resource region. Further, in the case that the judgment in the step 114 is affirmed, the step goes to a step 118 while the step 116 is skipped. Further, in the step 118, the step sets the buffer region for writing secured in the preceding step 112 as the write region, notifies the image processing module 38 requesting the writing of the head address of the write region, and demands to write the image data of the written object from the notified head address in sequence. Accordingly, the image processing module 38 of the write requesting source writes the image data in the write region (the unit buffer region or the write buffer region) that the head address is notified (refer also to FIG. 5B).

For example, in the case that the size of the unit buffer region is not integral multiples of the unit write data amount, there is generated a state in which the size of the free region in the unit buffer region having the free region is smaller than the unit write data amount, as shown in FIG. 5A as an example, by repeating the writing of the image data of the unit write data amount in the buffer 40A (the unit buffer region). In this configuration, the region in which the image data of the unit write data amount is written strides over the plural unit buffer regions, however, since the memory region used as the buffer 40A is secured in units of the unit buffer region in the exemplary embodiment, it is not secured that the unit buffer regions secured at the different timings correspond to the continuous region on the actual storage resource. On the contrary, in the exemplary embodiment, since the writing of the image data by the image processing module 38 is applied to the write buffer region secured independently from the unit buffer region for storing, and the image data once written in the write buffer region is copied to the single or plural unit buffer regions for storing, as shown in FIG. 5C, the notification of the write region applied to the image processing module 38 of the wiring request source may be executed only by notifying of the head address as mentioned above, regardless of whether or not the region in which the image data is written strides over the plural unit buffer regions, so that an interface with the image processing module 38 becomes simple.

In this configuration, in the case that the self module is constituted by the buffer module 40 generated by the application 32, in other words, in the case that the storage resource region used as the buffer 40A has been already secured, the step goes to a step 118 while the previously described steps 112 to 116 are skipped, notifies the image processing module 38 of the address of the already secured storage resource region as the address of the write region, and executes the writing of the image data in the write region.

If the writing of the image data in the write region by the preceding image processing module 38 is finished, the step goes to a step 120, and writes the image data written in the buffer region for writing in the buffer region for storing. In this configuration, in the case that the size of the free space in the unit buffer region having the free space is smaller than the unit write data amount, the image data written in the buffer region for writing is written in the plural unit buffer regions for storing, as shown in FIG. 5C. In the next step 122, the step updates the pointer indicating the end position of the valid data among the valid data pointers corresponding to the individual image processing modules 38 in the following stage of the self module, in such a manner that the end position of the valid data indicated by the pointer moves rearward only at the unit write data amount (refer also to FIG. 5C). Further, in the next step 124, the storage resource region secured in advance as the buffer region for writing is released by the resource management section 46B, and the data writing process is finished. In this configuration, the buffer region for writing may be structured such as to be secured at a time of initializing the buffer module 40 and be released at a time of deleting the buffer module 40.

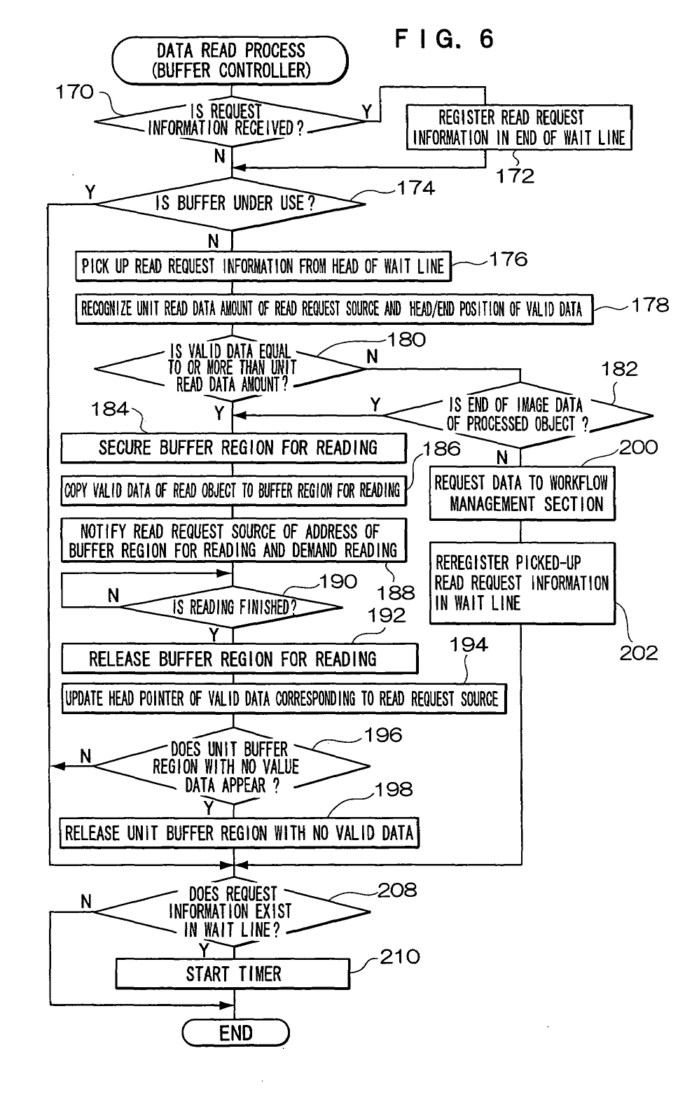

Subsequently, a description will be given of the data reading process executed, with referring to the FIG. 6, by the read controller 40D of the buffer module 40 in the case that the read request is input to the buffer module 40 from the following image processing module 38 (and in the case that the timer mentioned below times out). In this configuration, the data reading process described below may be started by calling the function or the method.

In the data reading process, the step first judges in a step 170 whether or not this time data reading process is activated by the factor that the read request is received from the following image processing module. In the case that the judgment is denied, the step goes to a step 174, however, in the case that the judgment is affirmed, the step goes to a step 172, and registers the read request information received at this time from the following image processing module in an end of a waiting line for reading. In the step 174, the step judges whether or not the buffer 40A of the self module is under access. Since the data writing is applied to the buffer 40A, the step goes to a step 208 in the case that the judgment is affirmed, and judges whether or not the read request information is registered in the waiting line for reading. In the case that the judgment is denied, the data reading process is finished, however, in the case that the judgment is affirmed, the step starts the timer and temporarily finishes the data reading process in a step 210. In the case that the timer is started, the data reading process is again activated if the timer times out, an untreated read request (information) registered in the waiting line for reading is again picked up, and the process corresponding to the read request is executed.

On the other hand, in the case that the judgment of the step 174 is denies, the step goes to a step 176, and picks up the read request information registered in the head from the waiting line for reading. In the next step 178, the step recognizes the image processing module 38 in the read request source on the basis of the request source identification information included in the read request information picked up from the waiting line for reading, recognizes the unit read data amount set by the image processing module 38 in the read request source, and recognizes the head position and the end position on the buffer 40A of the valid data corresponding to the image processing module 38 in the read request source, on the basis of the valid data pointer corresponding to the image processing module 38 in the read request source. In the next step 180, the step judges whether or not the valid data (the image data readable by the image processing module 38 in the read request source) corresponding to the image processing module 38 in the read request source exists equal to or more than the unit read data amount, on the basis of the head position and the end position of the valid data recognized in the step 178.

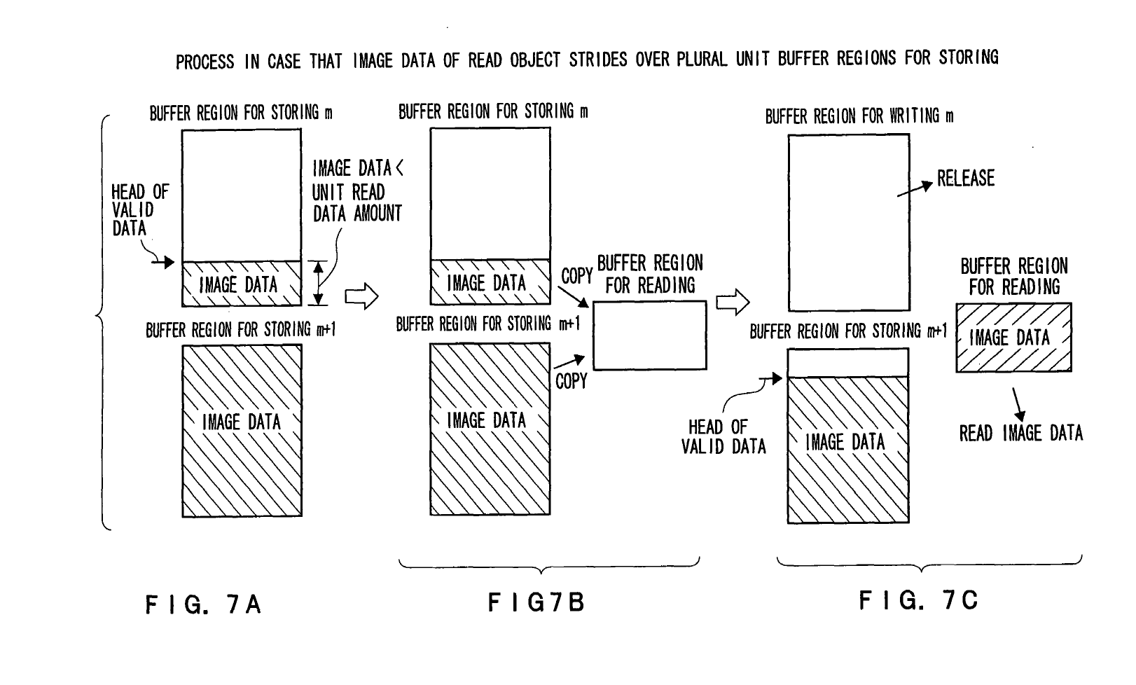

In the case that the judgment of the step 180 is denied, the step goes to a step 182, and judges whether or not the end of the valid data stored in the buffer 40A and readably by the image processing module 38 in the read request source is the end of the image data of the processed object. In the case that the valid data corresponding to the image processing module 38 in the read request source is stored at an amount equal to or more than the unit read data amount in the buffer 40A, or the valid data stored in the buffer 40A and corresponding to the image processing module 38 in the read request source is less than the unit read data amount, however the end of the valid data corresponds to the end of the image data of the processed object, the judgment in the step 180 or the step 182 is affirmed, and the step goes to a step 184. In the step 184, the step notifies the resource management section 46B of the unit read data amount corresponding to the image processing module 38 in the read request source as the size of the storage resource region to be secured, and requests the resource management section 46B to secure the storage resource region (the buffer region for reading: refer also to FIG. 7B) used for reading. In this configuration, if the remaining amount of the memory 14 exists at this time, the memory 14 is secured as the storage resource region, however, in the case that the remaining amount of the memory 14 is short, the storage region of the storage section 20 is secured as the storage resource region.

If the buffer region for reading is secured, in the next step 186, the step reads the valid data of the read object only at the unit read data amount from the buffer 40A, and writes the read valid data in the buffer region for reading. In the next step 188, the step notifies the image processing module 38 in the read request source of the head address of the buffer region for reading as the head address of the read region, and demands to read the image data from the notified head address in sequence. Accordingly, the image processing module 38 in the read request source executes reading of the image data from the read region (the buffer region for reading) that the head address is notified. In this configuration, in the case that the valid data of the read object is constituted by the data corresponding to the end of the image data of the processed object, the step notifies the image processing module 38 in the read request source of the size of the image data of the read object and the end of the image data of the processed object at a time of the read request of the image data. Further, in the case that the self module is constituted by the buffer module 40 generated by the application 32, the storage resource region (an aggregate of the unit buffer regions) used as the buffer 40A is constituted by a continuous region. Therefore, the following image processing module 38 may directly read the image data from the unit buffer region while the securing of the buffer region for reading, and the writing of the image date of the read object in the buffer region for reading are omitted.

As shown in FIG. 7A as an example, in the case that the data amount of the valid data stored in the unit buffer region storing the image data of the head section of the valid data is less than the unit read data amount, and the valid data of the read object strides over the plural unit buffer regions, the valid data of the read object at this time is not necessarily stored in the continuous region on the actual storage resource, but the image data is read from the buffer region for reading after the image data of the read object is once written in the buffer region for reading even in this configuration, as shown in FIGS. 7B and 7C. Therefore, the notification of the read region applied to the image processing module 38 of the read request source is executed only by notifying of the head address thereof as mentioned above, regardless of whether or not the image data of the read object is stored over the plural unit buffer regions, whereby the interface with the image processing module 38 becomes simple.

In the next step 190, the step judges whether or not the reading of the image data from the read region by the image processing module 38 in the read request source is finished, and repeats the step 190 until the judgment is affirmed. If the read finish is notified from the image processing module 38 in the read request source, the judgment of the step 190 is affirmed, and the step goes to a step 192, notifies the resource management section 46B of the head address and the size of the storage resource region secured as the buffer region for reading, and releases the storage resource region by the resource management section 46B. The buffer region for reading may be structured such as to be secured at a time of initializing the buffer module 40, and be released at a time when the buffer module 40 is deleted. Further, in a step 194, the step updates the pointer indicating the head position of the valid data in the valid data pointer corresponding to the image processing module 38 in the read request source by moving backward the head position of the valid data indicated by the pointer only at the unit read data amount (refer also to FIG. 7C).

In a step 196, the step judges whether or not the unit buffer region that all of the reading by each of the following image processing modules 38 of the stored image data is finished, that is, the unit buffer region that does not store the valid data appears in the unit buffer region constituting the buffer 40A, by referring each of the valid data pointers corresponding to the individual image processing modules 38 in the following stage and updating the pointer in the step 194. In the case that the judgment is denied, the step goes to a step 208, and the data reading process is finished via the steps 208 and 210 mentioned above, however, in the case that the judgment is affirmed, the step goes to a step 198, goes to a step 208 after releasing the unit buffer region storing no valid data by the resource management section 46B, and finishes the data reading process via the steps 208 and 210.

On the other hand, in the case that the data amount of the valid data stored in the buffer 40A and readable by the image processing module 38 in the read request source is less than the unit read data amount, and the end of the readable valid data is not the end of the image data of the processed object (in the case that no readable valid data is detected by the item (4) in FIG. 3B), each of the judgments in the steps 180 and 182 is denied, and the step goes to the step 200 and outputs the data request requesting a new image data to the workflow management section 46A (refer also to the item (5) in FIG. 3B). In this configuration, the process request is input to the preceding image processing module 38 of the self module, by the workflow management section 46A. Further, in the step 202, the step again registers the read request information picked up from the waiting line for reading in (the head or the end of) the original waiting line, and finishes the data reading process via the steps 208 and 210. Accordingly, the corresponding read request information is stored in the waiting line for reading and the execution of the process that is periodically picked up and requested is repeatedly tried, until the data amount of the readable valid data becomes equal to or more than unit read data amount, or the end of the readable valid data is detected as the end of the image data of the processed object (until the judgment in the step 180 or 182 is affirmed).

Although details will be described later, if the data request is input from the buffer module 40, the workflow management section 46A inputs the process request to the preceding image processing module 38 of the buffer module 40 in the data request source (refer also to the item (6) in FIG. 3B). If the preceding image processing module 38 comes to the state capable of writing the image data in the buffer module 40, on the basis of the process executed by the controller 38B of the preceding image processing module 38 by being triggered by the input of the process request, the data writing process (FIG. 4) mentioned above is executed by the input of the write request from the preceding image processing module 38, and the image data is written in the buffer 40A of the buffer module 40 from the preceding image processing module 38 (refer also to the items (7) and (8) in FIG. 3B). Accordingly, the reading of the image data from the buffer 40A is executed by the following image processing module 38 (refer to the item (9) in FIG. 3B).

In the data writing process and the data reading process mentioned above, there is executed an exclusive control that one accesses to the buffer 40A of the self module while the other stops the access to the buffer 40A. Accordingly, even if the CPU 12 of the computer 10 executes the processes or the threads corresponding to the individual modules constituting the image processing section 50 in parallel, the disadvantage caused by the simultaneous input or the approximately simultaneous input of the plural demands to the single buffer module 40 may be avoided. Accordingly, the CPU 12 of the computer 10 may execute the processes or the threads corresponding to the individual modules in parallel. Of course, the buffer modules may be achieved as the normal program or object.

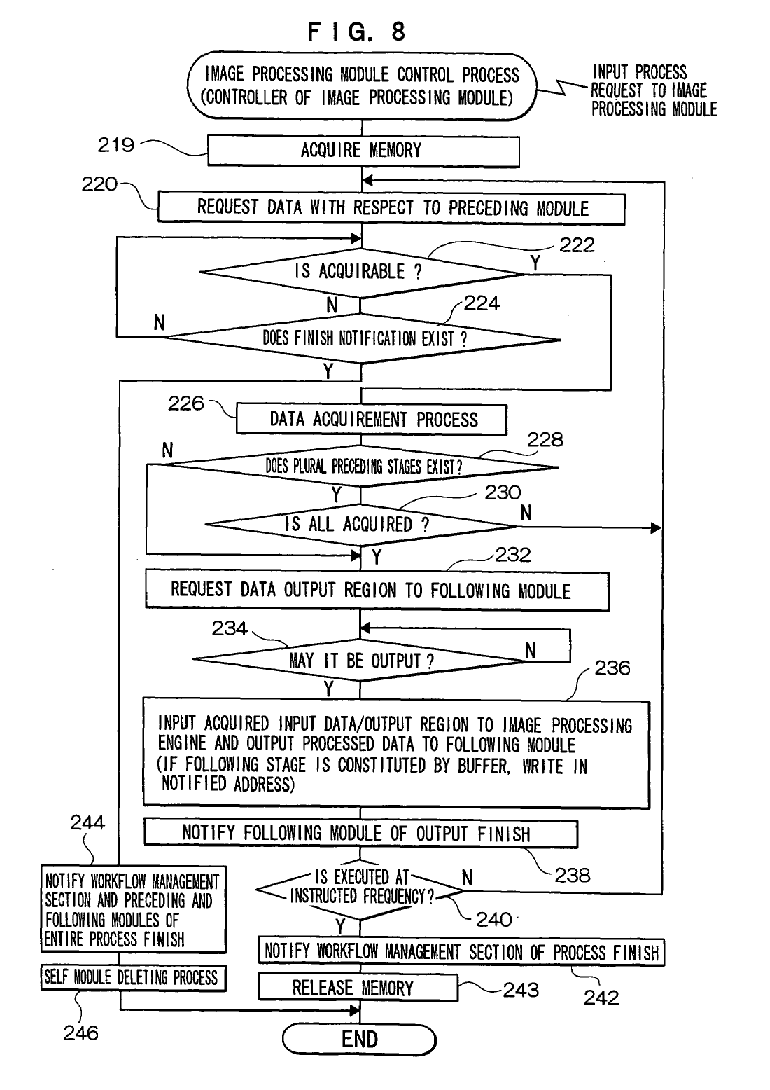

Subsequently, a description will be given of an image processing module control process (FIG. 8) executed by each of the controllers 38B of the individual image processing modules 38, each time when the process request is input to the individual image processing modules 38 constituting the image processing section 50 from the workflow management section 46A.

In the image processing module control process, in a step 219, the step first recognizes the size of the storage resource region (memory) used by the self module and the existence of the other resource used by the self module, on the basis of the kind, the content or the like of the image processing executed by the image processing engine 38A of the self module. In this configuration, the storage resource used by the image processing module 38 is mainly constituted by the storage resource necessary for executing the image processing by the image processing engine 38A, however, in the case that the preceding module is constituted by the image data supply section 22 or the following module is constituted by the image output section 24, there is a case that the storage resource for the buffer for temporarily storing the image data is necessary at a time of transmitting and receiving the image data with respect to the module in the preceding stage or the following stage. Further, in the case that the information such as the table or the like is included in the process parameter, there is a case that the storage resource region for holding it is necessary. Further, it requests the resource management section 46B to secure the storage resource region of the recognized size, and acquires the storage resource region secured by the resource management section 46B from the resource management section 46B. Further, in the case that (the image processing engine 38A of) the self module recognizes the necessity of the other resources than the storage resource, it requests the resource management section 46B to secure the other resources and acquires the other resources from the resource management section 46B.

In the next step 220, in the case that the module (the buffer module 40, the image data supply section 22, the image processing module 38 or the like) exists in the preceding stage of the self module, the step requests the preceding module the data (the process result of the image processing such as the image data, the analysis or the like). In the next step 222, the step judges whether or not the data may be acquired from the preceding module, and in the case that the judgment in the step 222 is denied, the step judges in a step 224 whether or not the finish of the entire process is notified. In the case that the judgment in the step 224 is denied, the step goes back to the step 222, and repeats the steps 222 and 224 until the data may acquired from the preceding module. In the case that the judgment in the step 222 is affirmed, the step executes in a step 226 a data acquiring process of acquiring the data from the preceding module and writing the acquired data in the storage resource region for temporarily storing the data in the storage resource regions acquired in the step 219.

In this configuration, in the case that the preceding module of the self module is constituted by the buffer module 40, if the data is requested in the preceding step 220 (the read request is generated), the head address of the read region is notified from the buffer module 40 and the reading of the image data is demanded, immediately in the case that the readable valid data is in the state of being stored in the buffer 40A of the buffer module 40 at the amount equal to or more than the unit read data amount or the end of the readable valid data coincides with the end of the image data of the processed object, or after changing to the state mentioned above in accordance that the preceding image processing module 38 of the buffer module 40 writes the image data in the buffer 40A of the buffer module 40 in the case that it is not in the state mentioned above. Accordingly, the judgment in the step 222 is affirmed, and the step goes to a step 226, and executes the data acquiring process of reading the image data of the unit read data amount (or the data amount less than the unit read data amount) from the read region that the head address is notified from the preceding buffer module 40, and writing in the storage resource region for the temporary storage (refer also to the item (3) in FIG. 3A).

Further, if the preceding module of the self module is constituted by the image data supply section 22, the establishment of the state in which the image data may be acquired by outputting the data request in the preceding step 220 is immediately notified from the preceding image data supply section 22, whereby the judgment in the step 222 is affirmed, and the step goes to the step 226, and executes the image data acquiring process of acquiring the image data at the unit read data amount from the preceding image data supply section 22, and writing in the storage resource region for the temporary storage. Further, if the preceding module of the self module is constituted by the image processing module 38, when the data request (the process request) is output in the preceding step 220, the establishment of the state in which the data (the image processing result) may be acquired by inputting the write request if the preceding image processing module 38 is in the state capable of executing the image processing is notified. Accordingly, the judgment in the step 222 is affirmed, and the step goes to the step 226, and executes the data acquiring process of writing the data output from the preceding image processing module 38 in the storage resource region for the temporary storage, by notifying the address of the storage resource region for the temporary storage writing the data by the preceding image processing module 38 and demanding the writing.

In the next step 228, the step judges whether or not the plural modules are coupled to the preceding stage of the self module. In the case that the judgment is denied, the step goes to a step 232 without executing any process, however, in the case that the judgment is affirmed, the step goes to a step 230, and judges whether or not the data is acquired from all the modules coupled to the preceding stage. In the case that the judgment in the step 230 is denied, the step goes back to the step 220, and the steps 220 to 230 are repeated until the judgment in the step 230 is affirmed. If all the data to be acquired from the modules in the preceding stage are prepared, the judgment in the step 228 is denied or the judgment in the step 230 is affirmed, and the step goes to a step 232.

In the next step 232, the step requests the following module of the self module the region for outputting the data, and repeatedly executes the judgment until the data output region may be acquired (until the head address of the data output region is notified) in the step 232. In this configuration, if the following module is constituted by the buffer module 40, the request of the region for outputting the data mentioned above is achieved by outputting the write request to the buffer module 40. If the data output region (the write region that the head address is notified from the buffer module 40 if the following module is constituted by the buffer module 40) is acquired (refer also to the item (4) in FIG. 3A), the step inputs in the next step 236 the data acquired in the preceding data acquiring process, (the head address of) the data output region acquired from the following module, and (the head address and the size of) the storage resource region for processing the image by the image processing engine among the storage resource regions acquired in the preceding step 219 to the image processing engine 38A, executes a predetermined image processing by using the storage resource region for processing the image with respect to the input data (refer also to the item (5) in FIG. 3A), and writes the data after being processed in the data output region (refer also to the item (6) in FIG. 3A). If the input of the data of the unit read data amount to the image processing engine 38A is finished, and all the data output from the image processing engine 38A is written in the data output region, the step notified the following module of the fact that the output is finished in the next step 238.

The process (the unit process) applied to the unit process data amount of data in the image processing module 38 is finished by the steps 220 to 238 mentioned above, however, there is a case that the executing frequency of the unit process is designated by the workflow management section 46A, in the process request input to the image processing module 38 from the workflow management section 46A. Accordingly, in the step 240, the step judges whether or not the executing frequency of the unit process reaches the executing frequency designated by the input process request. In the case that the executing frequency of the designated unit process is one, the judgment is affirmed unconditionally, however, in the case that the executing frequency of the designated unit process is two or more, the step goes back to the step 220, and the steps 220 to 240 are repeated until the judgment in the step 240 is affirmed. If the judgment in the step 240 is affirmed, the step goes to a step 242, notifies the workflow management section 46A the fact that the process corresponding to the input process request is finished, by outputting the process finish notification to the workflow management section 46A, and finishes the image processing module control process.

Further, if the process mentioned above is repeated each time when the process request is input from the workflow management section 46A, thereby processing the image data of the processed object to the end, the judgment in the step 224 is affirmed by notifying the end of the image data of the processed object from the preceding module, and the step goes to the step 244, and outputs each of the workflow management section 46A and the modules in the following stage an entire process finish notification meaning that the process with respect to the image data of the processed object (in this configuration, the image data of the processed object is constituted by the image data for one page in most cases, but may be constituted by the image data for plural pages) is finished. Further, in the next step 246, the step executes a process of deleting the self module by requesting the release of all the acquired resources, and finishes the image processing module control process.

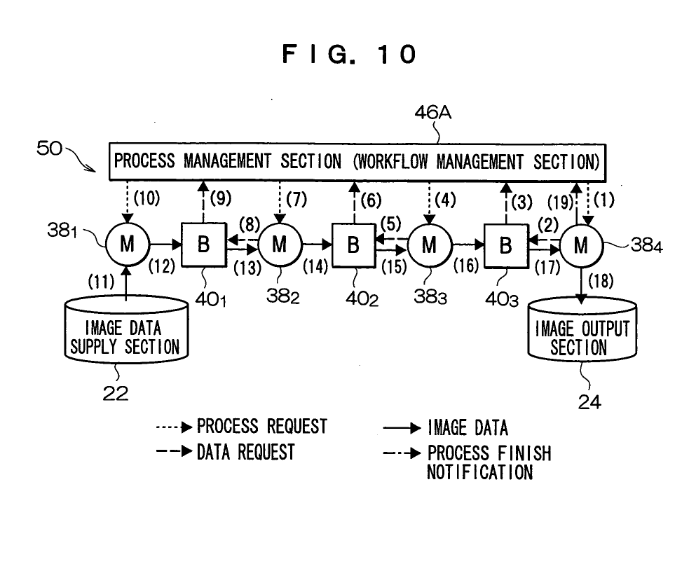

On the other hand, if the execution of the image processing is instructed by the application 32, the workflow management section 46A executes the parallel control process 1 shown in FIG. 9A. As is mentioned above, the executing frequency of the unit process may be designated in the input of the process request to the individual image processing modules 38 of the image processing section 50 by the workflow management section 46A, however, in a step 500 of the parallel control process 1, the step determines the executing frequency of the unit process designated by the process request at one time per the individual image processing module 38. The executing frequency of the unit process per one of the process requests may be determined, for example, in such a manner that the input frequency of the process request to the individual image processing modules 38 during the processing of the entire of the image data of the processed object is averaged, however, may be determined according to the other references. Further, in the next step 504, the step inputs the process request to the image processing module 38 in the final stage among the image processing section 50 (refer also to an item (1) in FIG. 10), and finishes the parallel control process 1.

In this configuration, in the image processing section 50 shown in FIG. 10, if the process request is input to an image processing module 38₄ in the final stage from the workflow management section 46A, a controller 38B of the image processing module 38₄ inputs the read request to a preceding buffer module 40₃ (refer to an item (2) in FIG. 10). At this time, since the valid data (the image data) capable of being read by the image processing module 38₄ is not stored in the buffer 40A of the buffer module 403, the buffer controller 40B of the buffer module 40₃ inputs the data request to the workflow management section 46A (refer to an item (3) in FIG. 10).

The workflow management section 46A executes the parallel control process 2 shown in FIG. 9B each time when the data request is input from the buffer module 40. According to this parallel control process 2, in a step 510, the step recognizes the preceding image processing module 38 (the image processing module 38₄ in this case) of the buffer module 40 (the buffer module 40₃ in this case) in the data request input source, and inputs the process request to the recognized preceding image processing module 38 (refer to an item (4) in FIG. 10) so as to finish the process.

If the process request is input, the controller 38B of the image processing module 38₃ inputs read request to the preceding buffer module 40₂ (refer to an item (5) in FIG. 10). Further, since the readable image data is not stored in the buffer 40A of the buffer module 40₂, the buffer controller 40B of the buffer module 40₂ inputs the data request to the workflow management section 46A (refer to an item (6) in FIG. 10). Even in the case that the data request is input from the buffer module 40₂, the workflow management section 46A inputs the process request to the preceding image processing module 38₂ thereof refer to an item (7) in FIG. 10) by again executing the parallel control process 2 mentioned above, and the controller 38B of the image processing module 38₂ inputs the read request to the preceding buffer module 40₁ (refer to an item (8) in FIG. 10). Further, since the readable image data is not stored in the buffer 40A of the buffer module 40₁, the buffer controller 40B of the buffer module 40₁ inputs the data request to the workflow management section 46A (refer to an item (9) in FIG. 10). Even in the case that the data request is input from the buffer module 40₁, the workflow management section 46A inputs the process request to the preceding image processing module 38₁ by again executing the parallel control process 2 mentioned above (refer to an item (10) in FIG. 10).

In this configuration, since the preceding module of the image processing module 38₁ is constituted by the image data supply section 22, the controller 38B of the image processing module 38₁ acquires the unit read data amount of image data from the image data supply section 22 by inputting the data request to the image data supply section 22 (refer to an item (11) in FIG. 10), and writes the image data obtained by the image processing applied to the acquired image data by the image processing engine 38A in the buffer 40A of the following buffer module 40₁ (refer to an item (12) in FIG. 10).

Further, if the valid data equal to or more than the unit read data amount readable by the following image processing module 38₂ is written, the buffer controller 40B of the buffer module 40₁ demands the image processing module 38₂ to read. According to this, the controller 38B of the image processing module 38₂ reads the unit read data amount of image data from the buffer 40A of the buffer module 40₁ (refer to an item (13) in FIG. 10), and writes the image data obtained by the image processing applied to the acquired image data by the image processing engine 38A in the buffer 40A of the following buffer module 40₂ (refer to an item (14) in FIG. 10). If the valid data equal to or more than the unit read data amount readable by the following image processing module 38₃ is written, the buffer controller 40B of the buffer module 40₂ demands the image processing module 38₃ to read, and the controller 38B of the image processing module 38₃ reads the unit read data amount of image data from the buffer 40A of the buffer module 40₂ (refer to an item (15) in FIG. 10), and writes the image data obtained by the image processing applied to the acquired image data by the image processing engine 38A in the buffer 40A of the following buffer module 40₃ (refer to an item (16) in FIG. 10).

Further, if the valid data equal to or more than the unit read data amount readable by the following image processing module 38₄ is written, the buffer controller 40B of the buffer module 40₃ demands the image processing module 38₄ to read. According to this, the controller 38B of the image processing module 38₄ reads the unit read data amount of image data from the buffer 40A of the buffer module 40₃ (refer to an item (17) in FIG. 10), and outputs the image data obtained by the image processing applied to the acquired image data by the image processing engine 38A to the image output section 24 corresponding to the module in the following stage (refer to an item (18) in FIG. 10).

Further, if the controller 38B of the individual image processing module 38 finishes the writing of the image data in the buffer 40A of the following buffer module 40, it inputs the process finish notification to the workflow management section 46A. The workflow management section 46A executes the parallel control process 3 shown in FIG. 9C each time when the process finish notification is input from the image processing module 38. In this parallel control process 3, the process is finished by again inputting the process request to the image processing module 38 in the process finish notifying source in the step 520.

As mentioned above, in the parallel control process by the workflow management section 46A, the image data of the processed object is in sequence delivered from the module in the preceding stage side to the following module side in increments of the smaller size (block) than one surface of the image, again inputting the process request to the image processing module 38 in the process finish notifying source each time when the process finish is notified from the optional image processing module 38, and there is executed the image processing applied to the image data of the processed object according to the parallel process system that the individual image processing modules 38 execute the image processing in parallel to each other. Further, if the image data supplied from the image data supply section 22 reaches the end of the image date of the processed object, the input of the entire process finish notification from the individual image processing module 38 to the workflow management section 46A is sequentially executed from the image processing module 38 in the preceding stage side.

The workflow management section 46A executes the parallel control process 4 shown in FIG. 9D each time when the entire process finish notification is input from the image processing module 38. In this parallel control process 4, in a step 540, the step judges whether or not the image processing module 38 in the entire process finish notification input source is constituted by the image processing module 38 in the final stage. In the case that the judgment is denied, the process is finished without executing any process, however, in the case that all the image data that the necessary image processing is applied to the image data of the processed object is output to the image output section 24, whereby the entire process finish notification is input from the image processing module 38 in the final stage, the judgment in the step 540 is affirmed, and the step goes to a step 542, and notifies the application 32 of the finish of the image processing, and the parallel control process 4 is finished. Further, the application 32 that the finish of the image processing is notified notifies the user of the finish of the image processing.

Further, while the image processing section 50 executes the image processing, the individual image processing modules 38 and (the threads corresponding to) the individual buffer modules 40 constituting the image processing section 50 repeat the acquirement and the release of the storage resource via the resource management section 46B described above. In this configuration, it is desirable that the storage resource allocated to each of the modules is constituted by the memory 14 having a high access speed, however, in the case that the thread corresponding to some module requests the acquirement of the storage resource with respect to the resource management section 46B, however the remaining amount of the memory 14 is short, whereby an error comes back from the resource management section 46B, the module lapse into a state in which it may not normally execute the processes on or later. Accordingly, the entire process in the image processing section 50 results in failure. Therefore, in order to avoid the matter that the lack of the remaining amount of the memory 14 immediately causes the failure of the entire process in the image processing section 50, the resource management section 46B according to the exemplary embodiment executes the processes mentioned below.

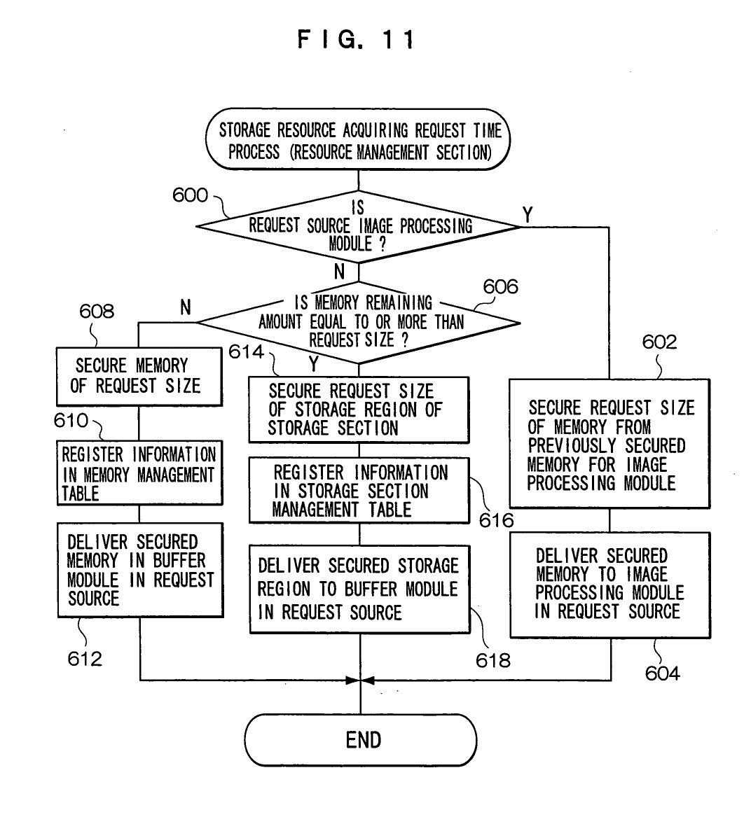

In other words, the resource management section 46B executes the storage resource acquiring request time process shown in FIG. 11 each time when the storage resource acquiring request is input from the optional thread corresponding to the optional module (the image processing module 38 or the buffer module 40). In this storage resource acquiring request time process, in a step 600, the step first judges whether or not the storage resource acquiring request source is constituted by the thread corresponding to the image processing module 38. The resource management section 46B according to the exemplary embodiment previously secures the memory region for allocating to the image processing module 38 through the operating system 30, and delivers the secured memory region to the image processing module 38 in the storage resource acquiring request source, by going to a step 602 in the case that the judgment is affirmed, securing the memory region of the size required by the storage resource acquiring request source from the memory region previously secured for the image processing module 38, and notifying the head address of the secured memory region in the next step 604. As mentioned above, in the exemplary embodiment, since the memory 14 having a high access speed is always allocated as the storage resource to the image processing module 38, the invention may prevent the lowering of the processing speed of the image processing module 38 and the lowering of the processing speed of the entire image processing in the image processing section 50 by extension from being generated, by allocating the storage resource having the lower access speed.

Further, in the case that the storage resource acquiring request source is constituted by the thread corresponding to the buffer module 40, the judgment of the step 600 is denied, and the step goes to a step 606, detects the remaining amount of the memory 14 by inquiring to the operation system 30 about the size (the remaining amount of the memory 14 capable of being secured through the operating system 30) of the unused region (except the region previously secured for the image processing module) in the memory 14, and judges whether or not the remaining amount of the detected memory 14 is equal to or more than the size of the storage resource requested by the storage resource acquiring request source. In the case that the judgment is affirmed, the step goes to a step 608, and secures the memory region of the request size through the operating system 30. Further, in a step 610, the step registers the information such as the ID of the buffer module 40 in the storage resource acquiring request source, the head address and the size of the secured memory region or the like, in the memory management table provided in the work memory or the like for managing the memory region allocated in the buffer module 40. Further, in a step 612, the step delivers the secured memory region to the buffer module 40 of the storage resource acquiring request source by notifying the thread corresponding to the buffer module 40 of the storage resource acquiring request source of the head address of the secure memory region, and finishes the storage resource acquiring request time process.

On the other hand, in the case that the storage resource acquiring request source is constituted by the thread corresponding to the buffer module 40, and the remaining amount of the memory 14 is smaller than the request size, the judgment in the step 606 is denied, and the step goes to a step 614, and secures the storage region of the storage section 20 at the request size. In the next step 616, the step registers the information such as the ID of the buffer module 40 in the storage resource acquiring request source, the head address and the size of the storage region of the secured storage section 20, the registered date in the table or the like, in the storage section management table provided in the work memory or the like for managing the storage region of the storage section 20 previously allocated in the buffer module 40. Further, in a step 618, the step delivers the storage region of the secured storage section 20 to the thread corresponding to the buffer module 40 of the storage resource acquiring request source by notifying the thread corresponding to the buffer module 40 of the storage resource acquiring request source of the head address of the storage region of the secures storage section 20, and finishes the storage resource acquiring request time process.

In this configuration, since the storage section 20 has the lower access speed as compared with the memory 14, the access (the writing or reading of the image data) with respect to the storage region of the storage section 20 delivered to the buffer module 40 is reduced in speed, however, since the access frequency to the storage resource is lower as compared with the case that the image processing module 38 executes the image processing by using the storage resource, a degree of the reduction of the processing speed according to the allocation of the storage resource having the low access speed becomes smaller than the image processing module 38. Further, since the storage resource (the storage region of the storage section 20) is secured so as to be delivered to the buffer module 40 in the request source even in the case that the remaining amount of the memory 14 is smaller than the request size, the entire process in the image processing section 50 may be continued regardless of the lack of the remaining amount of the memory 14.

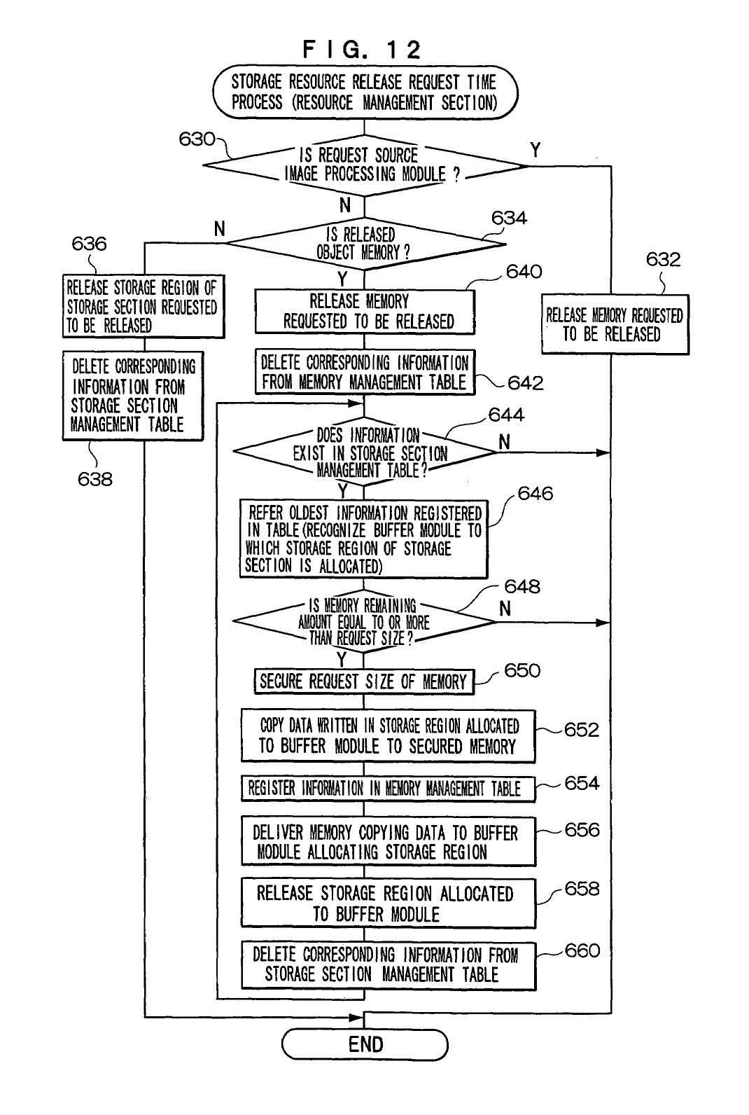

Further, the resource management section 46B executes the storage resource release request time process shown in FIG. 12 each time when the storage resource release request is input from the optional thread corresponding to the optional module (the image processing module 38 or the buffer module 40). In this storage resource release request time process, in a step 630, the step first judges whether or not the storage resource release request source is constituted by the thread corresponding to the image processing module 38. In the case that the judgment is affirmed, the storage resource of the released object is constituted by the memory region previously secured for allocating to the image processing module 38. Accordingly, the step goes to a step 632, releases the memory region requested to be released through the operating system 30 and finishes the process.

Further, in the case that the storage resource release request source is constituted by the thread corresponding to the buffer module 40, the judgment of the step 630 is denied, and the step goes to a step 634, and judges whether or not the storage resource of the released object is constituted by the memory region. In the case that the storage resource of the released object is constituted by the storage region of the storage section 20, the judgment is denied, and the step goes to a step 636, and releases the storage region of the storage section 20 requested to be released. Further, in a step 638, the step deletes the information corresponding to the storage region released at this time among the information registered in the storage section management table, from the storage section management table, and finishes the process.

On the other hand, in the case that the storage resource release request source is constituted by the thread corresponding to the buffer module 40, and the storage resource of the released object is constituted by the memory region, the judgment in the step 634 is affirmed, and the step goes to a step 640 and releases the memory region requested to be released through the operating system 30. Further, in a step 642, the step deletes the information corresponding to the memory region released at this time among the information registered in the memory management table, from the memory management table. In the next step 644, the step judges whether or not the information is registered in the storage section management table, that is, whether or not the buffer module 40 to which the storage region of the storage section 20 is allocated exists as the storage resource. In the case that the judgment is denied, the process is finished, however, in the case that the judgment is affirmed, the step goes to a step 646, and recognizes the buffer module 40 having the oldest time when the storage region of the storage section 20 is allocates, among the buffer modules 40 to which the storage region of the storage section 20 is allocated as the storage resource, by referring to the information having the oldest registered date in the table, among the information registered in the storage section management table.

In the next step 648, the step judges whether or not the remaining amount of the memory 14 is equal to or more than the request size (the size of the storage region of the storage section 20 allocated to the buffer module 40) by the buffer module 40 recognized in the step 646. In the case that the judgment is denied, there is not generated a condition capable of allocating the memory region to the recognized buffer module 40. Accordingly, the process is finished. However, in the case that the judgment in the step 648 is affirmed, the memory region may be allocated to the recognized buffer module 40. Accordingly, the step executes the process of allocating the memory region in place of the storage region of the allocated storage section 20 to the recognized buffer module 40, in the next step 650 or later.

In other words, in the step 650, the step secures the memory region of the request size by the recognized buffer module 40 through the operating system 30. In the next step 652, the step copies the data written in the storage region of the storage section 20 allocated in the recognized buffer module 40 in the memory region secured in the step 650. Further, in a step 654, the step registers the information such as the ID of the recognized buffer module 40, the head address and the size of the secured memory region or the like, in the memory management table. In the next step 656, the step executes an allocation (a delivery) of the memory region copying the data in place of the storage region of the allocated storage section 20, by notifying the recognized buffer module 40 of the head address of the memory region copying the data. Further, in a step 658, the step releases the storage region of the storage section 20 allocated to the buffer module 40 to which the memory region is newly allocated, and in the next step 660, the step deletes the information corresponding to the storage region released at this time among the information registered in the storage section management table, from the storage section management table.

Further, the step goes back to a step 644 after executing the process in the step 660. Accordingly, according to the storage resource release request time process, the step judges whether or not the memory region may be reallocated as the storage resource to the buffer module 40 to which the storage region of the storage section 20 is allocated as the storage resource, at a timing when the remaining amount of the memory 14 is increased, by releasing the memory region allocated to the buffer module 40, in the order that the allocated time of the storage region of the storage section 20 is older. If the memory region may be allocated, the memory region is allocated in place of the storage region of the storage section 20. Accordingly, since the storage region of the storage section 20 is allocated as the storage resource to the buffer module 40, the memory region is reallocated as the storage resource at a time when the remaining amount of the memory 14 is increased, whereby a state in which the processing speed of the buffer module 40 is lowered may be prevented from continuing for a long period, even if the processing speed of the buffer module 40 is lowered. Therefore, an adverse effect may be prevented from being continuously applied to the processing speed of the entire process in the image processing section 50 by a temporary lack of the remaining amount of the memory 14.

Further, since the judgment whether or not the memory region may be reallocated as the storage resource is executed in the order that the time when the storage region of the storage section 20 is allocated is older, a necessary time after the storage region of the storage section 20 is temporality allocated as the storage resource until the memory region is reallocated as the storage resource may be averaged with respect to the individual buffer modules 40.

### Second Exemplary Embodiment

A description will be given below of a second exemplary embodiment according to the invention. In this configuration, since the second exemplary embodiment has the same structure as that of the first exemplary embodiment, a description of the structure will be omitted by attaching the same reference numerals to the respective sections, and a description will be given below of an operation of the present second exemplary embodiment.

As described in the first exemplary embodiment, since the image processing section 50 is constructed by coupling the image processing module 38 and the buffer module 40 in the pipe line aspect or the directed acyclic graph aspect, and the individual image processing modules 38 may not start the image processing in the self module until the image data equal to or more than the unit read data amount is accumulated in the buffer module 40 coupled to the preceding stage (in this configuration, except the image processing module 38 in the forefront stage coupled to the image data supply section 22), the progress of the image processing in the individual image processing modules 38 depends on the progress stage of the image processing in the image processing module 38 positioned at the more front stage, and a processing efficiency is improved more in the case that the image processing in the image processing module positioned in the preceding stage side in the pipe line aspect or the directed acyclic graph aspect is executed by priority, among the respective image processing modules, particularly at a time of starting the execution of the series of image processing in the image processing section or in the period near the time.

Further, in the structure in which the image processing module 38 and the buffer module 40 are coupled in the pipe line aspect or the directed acyclic graph aspect, the progress of the image processing is always later in the image processing module 38 in the following stage side than the image processing module 38 in the preceding stage side, and the remaining amount of the image data of the processed object is always more in the image processing module 38 in the following stage side. Therefore, the processing efficiency is improved more in the case that the execution priority of the image processing in the image processing module positioned in the following stage side is made higher. Particularly, at the time when the execution of the series of image processing in the image processing section is finished or in the period near the time, it is desirable in view of the processing efficiency to make the execution priority of the image processing in the image processing module positioned in the following stage side higher in accordance that the image processing module 38 that the entire process is finished is increased little by little from the preceding stage side.

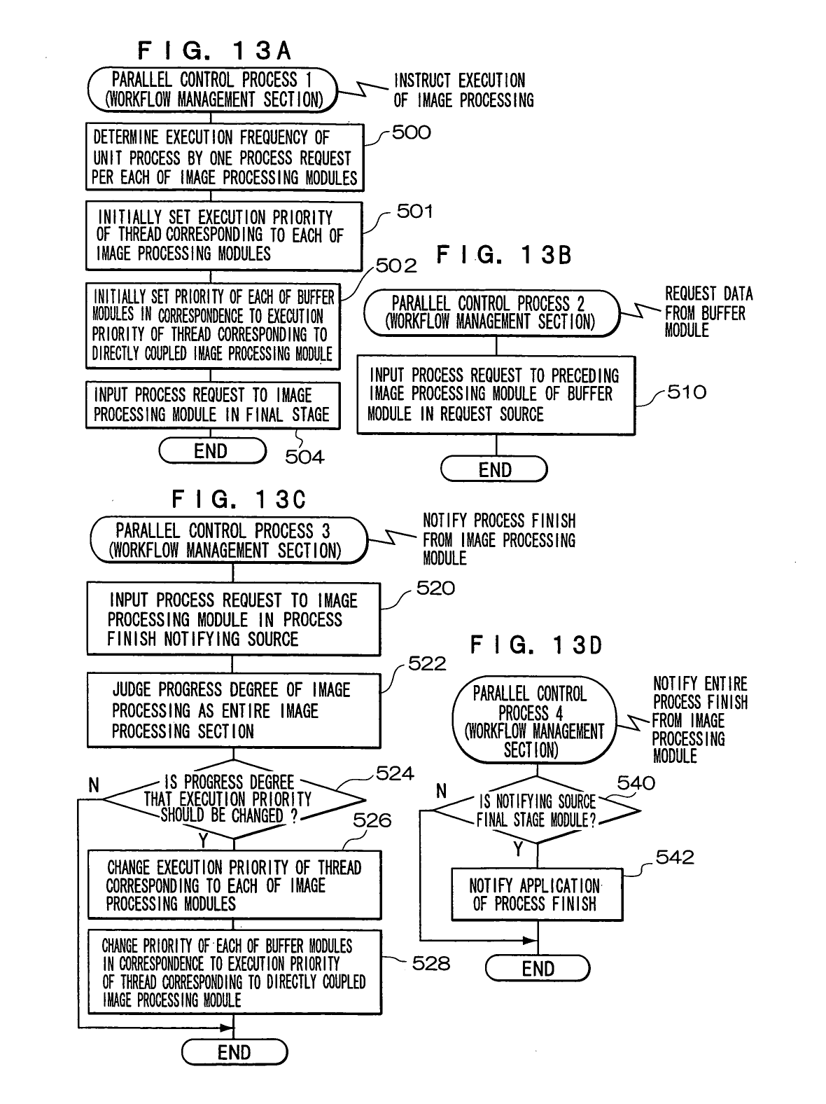

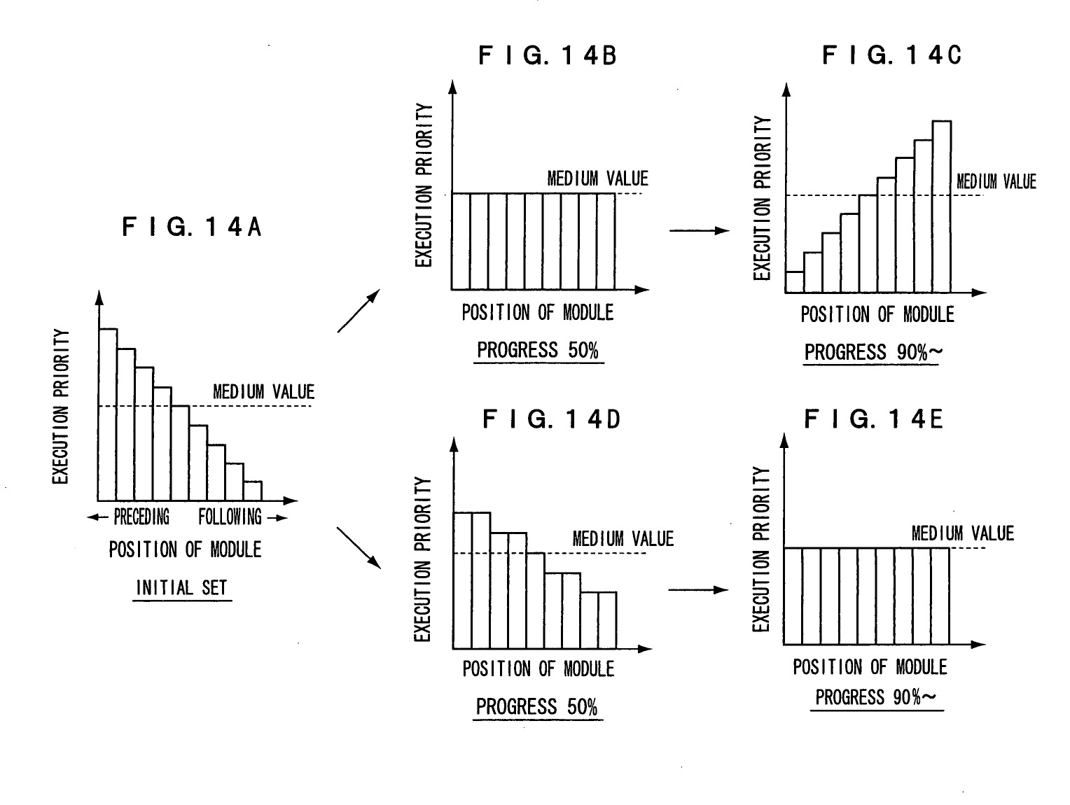

On the basis of the structure mentioned above, the workflow management section 46A according to the present second exemplary embodiment executes a parallel control process shown in FIG. 13. In other words, in the parallel control process 1 (refer to FIG. 13A) executed at a time when the execution of the image processing is instructed by the application 32, in a step 501, the step executes an initial setting of an execution priority of the individual threads in such a manner that the execution priority of the individual threads executing the programs of the individual image processing modules 38 becomes higher as the position of the image processing module 38 goes to the preceding stage side in the coupling aspect according to the pipe line aspect or the directed acyclic graph aspect comes to the preceding stage side, as shown in FIG. 14A as an example.

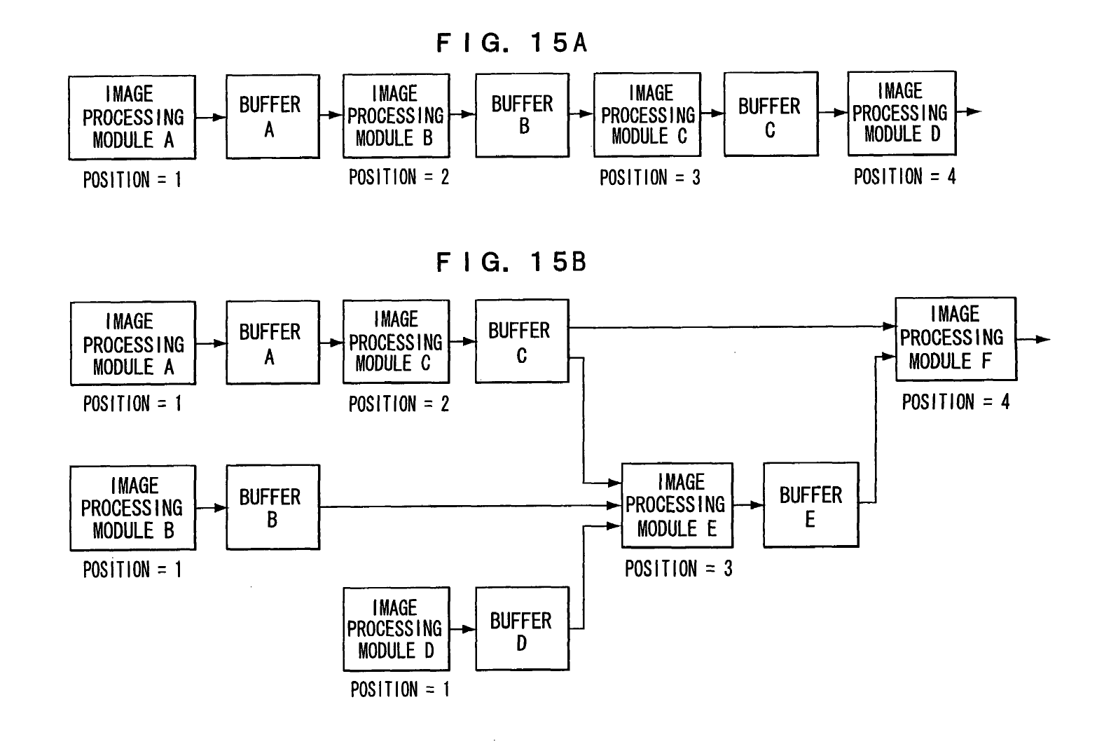

In the case that the image processing section is constituted by the pipe line aspect, the “position of the image processing module 38” mentioned above may be determined on the basis of a position value applied according to an ascending order from the image processing module 38 in the head (the forefront stage) as shown in FIG. 15A (or a position value applied according to a descending order from the image processing module 38 in the final (the final stage)). In the case that the image processing section is constituted by the directed acyclic graph aspect, the position value may be applied according to an ascending order from the image processing module 38 in the head (the forefront stage) as shown in FIG. 15B (or according to a descending order from the image processing module 38 in the final (the final stage)). Further, in the case of the image processing module 38 (the image processing module E in the example in FIG. 15B) acquiring the image data from the plural image processing modules via the buffer module, the position value may be applied on the basis of the maximum value (or the minimum value) of the position value applied to the plural image processing modules in the preceding stage, and the judgment may be executed on the basis of the position value.

Further, in the case that the execution priority of the corresponding thread is increased as the position of the image processing module 38 goes to the preceding stage side in the coupling aspect of the pipe line aspect or the directed acyclic graph aspect comes to the preceding stage side, for example, if the execution priority settable to the corresponding thread to the image processing module include nine stages from 1 to 9, and the position value is applied to the individual image processing module 38 from the preceding stage side according to an ascending order on the basis of initial value=1, the execution priority may be set to the corresponding thread to the individual image processing module 38 as follows.

Execution priority=10−(position value)

In which the execution priority=1 in the case that the relation execution priority<1 is established.

Otherwise the execution priority may be set by using a specific monotone descending function (for example, a function that the execution priority linearly descends with respect to an increase of the position value) that the execution priority comes to “9” at a time when the position value is the minimum value, and the execution priority comes to “1” at a time when the position value is the maximum value. Accordingly, the position of the corresponding image processing module 38 according to the coupling aspect of the pipe line aspect or the directed acyclic aspect is executed by the CPU 12 on the basis of the higher execution priority toward the thread in the preceding stage side, at a time point when the series of image processings are started by the image processing section, and the image processing may be executed at a higher processing efficiency by effectively utilizing the CPU 12.

Further, in the next step 502, the priority of the individual buffer module 40 constituting the image processing section 50 is set in correspondence to the execution priority of the corresponding thread to the image processing module 38 directly coupled to the individual buffer module 40. The priority of the individual buffer module 40 may be specifically brought into line with the execution priority of the corresponding thread to the image processing module 38, for example, existing in the preceding stage side of the individual buffer module 40, or may be brought into line with the execution priority of the corresponding thread to the image processing module 38 existing in the following stage side of the individual buffer module 40, or may employ any one of an average value, a maximum value and a minimum value of the execution priorities of the corresponding threads to the plural image processing modules 38 existing in the preceding stage side and the following stage side of the individual buffer modules 40.

In this configuration, the priority of the buffer module 40 mentioned above corresponds to the information used in a storage resource acquiring request time process and a storage resource release request time process mentioned below, and the information having no relation to the execution priority of the corresponding thread to the buffer module 40. The execution priority of the corresponding thread to the buffer module 40 may be set as described above in place of this, and the execution priority of the corresponding thread to the buffer module 40 may be also used in the storage resource acquiring request time process and the storage resource release request time process mentioned below.

Further, the workflow management section 46A according to the present second exemplary embodiment judges in a step 522 the progress degree of the image processing as the entire image processing section, in the parallel control process 3 (refer to FIG. 13C) executed each time when the process finish notification is input from the image processing module 38. This judgment may be executed, for example, by constructing the individual image processing module 38 in such a manner as to transmit the progress degree information capable of judging the progress degree of the image processing in the individual image processing module 38 together at a time when the process finish notification is transmitted to the workflow management section 46A from the individual image processing module 38, and compiling the progress degree of the image processing as the entire image processing section from the corresponding progress degree information to the individual image processing module 38, after the workflow management section 46A holds the simultaneously received progress degree information each time when it receives the process finish notification from the individual image processing module 38 (overwriting the already held progress degree information by the newly received progress degree information in the case of already holding the previously received progress degree information from the same image processing module 38).

It is preferable that the progress degree information is constituted by an information that a load applied to (the CPU 12 executing the corresponding thread to) the image processing module 38 is as small as possible at a time of deriving, and the progress degree information may employ, for example, an information expressing a ratio of the processed image data (a ratio of the data amount, a ratio of the line number or the like in detail) of the individual image processing module 38 with respect to the entire image data of the processed object. Further, the information expressing the data amount and the line number of the processed image data may be transmitted as the progress degree information from the individual image processing module 38, and the progress degree (the ratio mentioned above or the like) in the individual image processing module 38 may be computed by the workflow management section 46A.

In the next step 524, the step judges whether or not the progress degree of the image processing as the entire image processing section judged in the step 522 comes to a value that the execution priority of the corresponding thread to the individual image processing module 38 should be changed. In this configuration, it is not necessary to frequently change the execution priority of the thread, and in order to avoid an excessive load application to the CPU 12 generated by frequently executing the change of the execution priority, the judging condition in the judgment in the step 524 may employ a judging condition that the execution priority is changed at such loose intervals as to prevent the extra load, for example, such that the judgment mentioned above is affirmed each time when the progress degree of the image processing is 10% increased after the preceding change (or the initial setting) of the execution priority of the thread.

In the case that the judgment mentioned above is denied, the parallel control process 3 is finished without executing any process, however, in the case that the judgment is affirmed, the execution priority of the corresponding thread to the individual image processing module 38 is changed and set in a step 526 in such a manner that the execution priority is lowered step by step according to the progress of the image processing with respect to the thread in which the high execution priority is set at a time of the initial setting, on the basis of a medium value (or an average value) of the execution priorities set in the respective threads at a time of the initial setting, and the execution priority is increased step by step according to the progress of the image processing with respect to the thread in which the low execution priority is set at a time of the initial setting.

In this configuration, the change of the execution priority in the step 526 may be executed such as to increase the change amount of the execution priority of the corresponding thread in accordance that the position of the image processing module 38 comes close to the forefront stage or the final stage, for example, such as to reverse a magnitude relation between the execution priority of the corresponding thread to the image processing module 38 in the preceding stage side and the execution priority of the corresponding thread to the image processing module 38 in the following stage side in a final stage of the image processing as the entire image processing section, as shown in FIGS. 14B and 14C. The change of the execution priority in the step 526 may be executed such that the execution priorities of the corresponding threads to the respective image processing modules 38 becomes fixed in the final stage of the image processing as the entire image processing section, as shown in FIGS. 14D and 14E as an example. The image processing may be executed at a high processing efficiency while the CPU 12 is effectively utilized by changing the execution priority of the corresponding thread to the individual image processing module 38 according to the series of image processings in the image processing section.

Further, in the next step 528, the priority of the individual buffer module 40 is changed and set in the same manner as the step 502 of the parallel control process 1 in correspondence to the execution priority of the corresponding thread to the changed and set individual image processing module 38, and the parallel control process 3 is finished. In this configuration, initially setting and changing the execution priority of the corresponding thread to the individual image processing module 38 and the priority of the individual buffer module 40 as mentioned above corresponds to the execution priority controller described in claims. The processing efficiency of the entire image processing in the image processing section 50 may be improved by initially setting and changing the execution priority of the corresponding thread to the individual image processing module 38 as mentioned above.

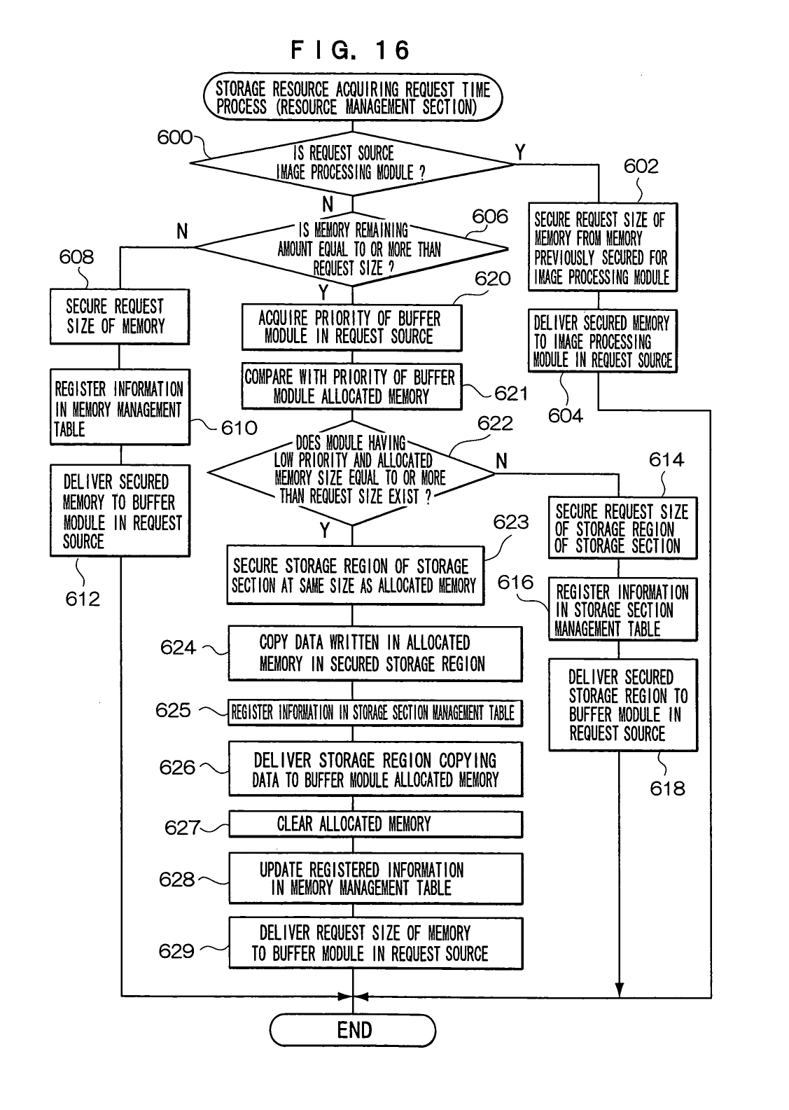

Next, a description will be given only of different sections from the storage resource acquiring request time process (FIG. 11) described in the first exemplary embodiment, with respect to the storage resource acquiring request time process according to the second exemplary embodiment, with reference to FIG. 16. In the storage resource acquiring request time process according to the second exemplary embodiment, the storage resource acquiring request source corresponds to the corresponding thread to the buffer module 40 (denied by the judgment in the step 600), and in the case that the remaining amount of the memory 14 is smaller than the request size (affirmed by the judgment in the step 606), the step goes to a step 620, and acquires the priority of the buffer module 40 in the storage resource acquiring request source from the workflow management section 46A or the like.

Further, in a step 621, the step acquires the priority of the individual buffer module 40 (the buffer module 40 to which the memory region is allocated as the storage resource) that the information is registered in the memory management table from the workflow management section 46A or the like, and compares the acquired priority of the individual buffer module 40 with the priority of the buffer module 40 in the storage resource acquiring request source acquired in the step 620. Further, in a step 622, the step judges on the basis of the comparison result of the priority in the step 621 whether or not the priority is lower than the buffer module 40 in the storage resource acquiring request source, and the buffer module 40 that the size of the allocated memory region is equal to or more than the request size exist. In the case that the judgment is denied, the memory region may not be allocated to the buffer module 40 in the storage resource acquiring request source. Therefore, the step in sequence executes the securing of the storage region of the storage section 20 for the request size (a step 614), a registration of the information in the storage section management table (a step 616), and a delivery of the storage region of the secured storage section 20 to the buffer module 40 in the storage resource acquiring request source (a step 618).

On the other hand, in the case that the buffer module 40 corresponding to the condition of the step 622 exists, the step goes to a step 623 from the step 622, and the storage region of the storage section 20 is secured at the same size as the memory region allocated to the buffer module 40 corresponding to the condition mentioned above. In the next step 624, the step copies the data to the storage region of the storage section 20 secured from the memory region allocated to the buffer module 40 corresponding to the condition mentioned above. Further, in a step 625, the step registers the information such as the ID of the buffer module 40 corresponding to the condition mentioned above, the head address and the size of the storage region of the secured storage section 20, or the like in the storage section management table. Further, in a step 626, the step executes a delivery (reallocation) of the storage region of the storage section 20 copying the data in place of the previously allocated memory region, with respect to the buffer module 40 corresponding to the condition mentioned above (the buffer module 40 to which the memory region is allocated as the storage resource).

Further, in a step 627, the step clears the memory region allocated to the buffer module 40 mentioned above. In the next step 628, the step rewrites the information in the memory region registered in the memory management table into the ID of the buffer module in the storage resource acquiring request source as the ID of the buffer module 40, and rewrites the size so as to update if the allocated size is changed (in the case that the request size is smaller than the size of the memory region allocated to the buffer module mentioned above). Further, in a step 629, the step executes an allocation (a delivery) of the memory region by notifying the buffer module 40 in the storage resource acquiring request source of the head address of the memory region allocated to the other buffer module 40. In the case that the fluctuation of the allocated size exists, the process of releasing an unnecessary partial memory region is also executed.

As mentioned above, in the storage resource acquiring request time process according to the present second exemplary embodiment, in the case that the acquirement of the storage resource is requested from the buffer module 40, however, if the remaining amount of the memory 14 is short, the buffer module 40 having the lower priority than the buffer module 40 in the storage resource acquiring request source exists in the buffer module 40 to which the memory region is already allocated, and the size of the memory region allocated to the buffer module 40 having the lower priority is equal to or more than the request size, the storage region of the storage section 20 is reallocated to the buffer module 40 having the lower priority, and the memory region allocated to the buffer module 40 having the lower priority is allocated to the buffer module 40 in the storage resource acquiring request source. Accordingly, the memory region is allocated by priority to the buffer module 40 having the higher priority, and the processing efficiency of the entire image processing in the image processing section 50 may be further improved.

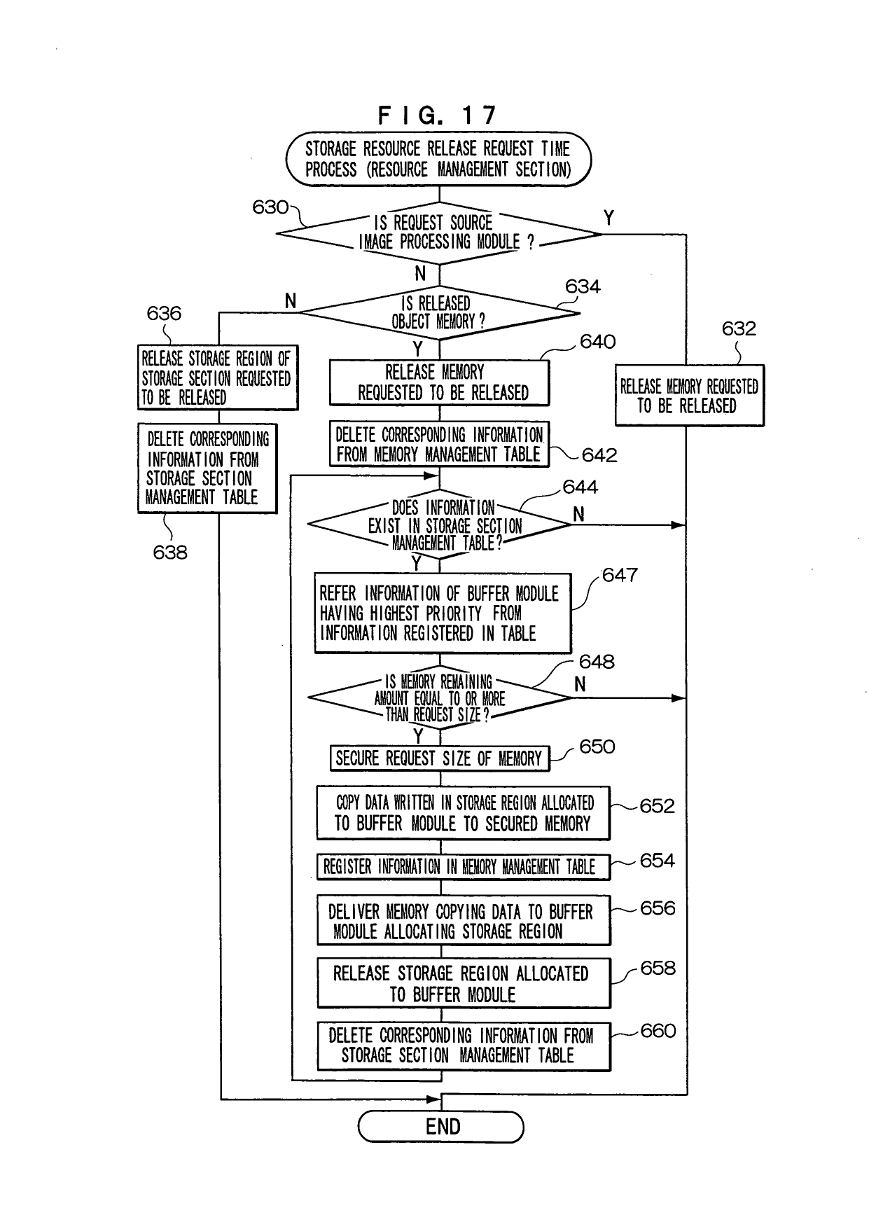

Subsequently, a description will be given of a storage resource release request time process (FIG. 17) according to the present second exemplary embodiment. In the storage resource release request time process (FIG. 12) described in the first exemplary embodiment, the judgment whether or not the memory region may be reallocated as the storage resource is executed according to the order that the time when the storage region of the storage section 20 is allocated is older, by recognizing the buffer module 40 having the oldest allocated time of the storage region of the storage section 20, among the buffer modules 40 to which the storage region of the storage section 20 is allocated as the storage resource, in the step 646. However, in the storage resource release request time process according to the present second exemplary embodiment, in place of the step 646 mentioned above, the step recognizes in a step 647 the buffer module 40 having the highest priority among the buffer module 40 to which the storage region of the storage section 20 is allocated as the storage resource. Accordingly, the judgment whether or not the memory region may be reallocated to the buffer module 40 to which the storage region of the storage section 20 is once allocated as the storage resource is executed according to the descending order of the priority, and a probability that the processing efficiency of the entire image processing in the image processing section 50 is further improved may be improved.

In this configuration, in the second exemplary embodiment, the execution priority of the corresponding thread to the individual image processing module 38 may be changed in correspondence to a frequency (a wait generating frequency) generating “wait” (a state of waiting until the valid data of the buffer module 40 becomes equal to or more than the unit read data amount) in the following image processing module mentioned above as well as the data request is input from the following buffer module 40 mentioned above because the read request is input to the following buffer module 40 mentioned above from the image processing module 38 (the image processing module 38 having the position value=the position value of the self module+1) coupled to the following stage via the following buffer module 40, however, the effective data stored in the following buffer module 40 mentioned above is less than the unit read data amount, with respect to the individual image processing modules.

Specifically, the image processing module 38 that the wait generating frequency is more than the average value generates a comparatively large number of “wait” in the image processing module 38 coupled to the following stage via the following buffer module 40, it is determined that the image processing in the image processing module 38 forms a bottleneck of the image processing as the entire image processing section, however, there is increased the execution priority of the corresponding thread to the image processing module 38 mentioned above. Further, in the image processing module 38 that the wait generating frequency is less than the average value, since the “wait” generating frequency is comparatively small in the image processing module 38 coupled to the following stage via the following buffer module 40, the efficiency of the image processing may be improved as the entire image processing section by giving priority to the image processing in the other image processing modules 38 having the comparatively more wait generating frequency than the image processing module 38, however, the execution priority of the corresponding thread to the image processing module 38 mentioned above is lowered.

Accordingly, the execution priority of the corresponding thread to the individual image processing module 38 may be optimized in correspondence to (a deviation between the average value of the wait generating frequency and) the wait generating frequency in the following image processing module 38, and the image processing may be executed at a high processing efficiency by effectively utilizing the CPU 12. Further, since the acquiring request information registered in a memory acquirement wait line is arranged according to the execution priority set in such a manner as mentioned above, even in the case that the memory region is allocated by canceling the execution stop state of the thread for the reason why the securable memory region is increased after the required memory region may not be secured and the executions of the plural threads are stopped, the later processes in the image processing section 50 may be executed at a high processing efficiency.

In this configuration, in the aspect mentioned above, there may be employed a frequency obtained by adding a frequency that the individual image processing module 38 writes the image data in the following buffer module 40 however the valid data of the following buffer module 40 does not reach the unit read data amount of the following image processing module 38 to the frequency that the data request is input from the following buffer module 40, that is, the frequency that the “wait” is generated in the image processing module 38 coupled to the following stage via the following buffer module 40. In this configuration, since the wait generating frequency comes to a value more accurately reflecting the degree of “wait” in the following image processing module 38, this case is preferable.

Further, in the aspect mentioned above, in addition to changing the execution priority of the corresponding thread to the individual image processing module 38 in correspondence to the “wait” generating frequency in the following image processing module 38 coupled via the following buffer module 40, the structure may be made such as to change the execution priority of the thread in correspondence to the “wait” generating frequency in the self module (in detail, the thread corresponding to the image processing module 38 having the comparatively more wait generating frequency lowers the execution priority, and the thread corresponding to the image processing module 38 having the comparatively less wait generating frequency increases the execution priority).

Further, the structure may be made such as to change the execution priority of the corresponding thread to the individual image processing module 38 in correspondence to the ratio of the data amount of the image data accumulated and stored in the individual buffer module 40 with respect to the unit data amount at a time when the following image processing module 38 of the individual buffer module 40 acquires the image data from the individual buffer module 40.

Specifically, in the buffer module 40 that the ratio of the accumulated data amount is smaller than the average value, the data amount of the effective data is more lack as compared with the unit read data amount in the following image processing module 38, there is a high possibility that a comparatively large number of “wait” are generated in the following image processing module 38, and there is a high possibility that the image processing in the preceding image processing module 38 of the buffer module 40 forms a bottleneck of the image processing as the entire image processing section. However, the execution priority of the corresponding thread to the image processing module 38 is increased. Further, since a sufficient data amount of effective data is stored in the buffer module 40 that the ratio of the accumulated data amount is larger than the average value, as compared with the unit read data amount in the following image processing module 38, the efficiency of the image processing as the entire image processing section may be improved by giving priority to the image processing in the preceding image processing module 38 of the other buffer modules 40 having the comparatively smaller ratio of the accumulated data amount, as compared with the preceding image processing module 38 of the buffer module, however, the execution priority of the corresponding thread to the image processing module 38 mentioned above is lowered.

Accordingly, the execution priority of the corresponding thread to the individual image processing module 38 is optimized in correspondence to (the deviation between the average value of the ratio of the accumulated data amount and) the ratio of the accumulated data amount in the following buffer module 40, and the image processing may be executed at a high processing efficiency by effectively utilizing the CPU 12. Further, since the acquiring request information registered in the memory acquirement wait line is arranged according to the execution priority set as mentioned above, the later process in the image processing section 50 may be executed at a high processing efficiency even in the case that the memory region is allocated by canceling the execution stop state of the thread for the reason why the securable memory region is increased after stopping the execution of the plural threads without securing the requested memory region.

Further, in the first exemplary embodiment and the second exemplary embodiment, the description is given of the aspect that the resource management section 46B of the process management section 46 serving as the storage resource management unit according to the invention processes the storage resource acquirement/release requests from each of the modules of the image processing section 50 in a lump, however, the invention is not limited to this, but may be structured such that the resource management section serving as the storage resource management unit according to the invention is provided within the individual buffer module 40 and within the individual image processing module 38, and the resource management section within the individual module processes the storage resource acquirement/release requests output from the controller (the buffer controller 40B or the controller 38B) within the same module. In this configuration, the structure may be made such that the memory region of a predetermined size is previously allocated to the individual module, and the resource management section provided in the individual module allocates the memory region to the storage resource acquiring request from the controller within the same module during a time when the remaining amount of the memory region previously allocated to the self module is sufficient, and allocates the storage region of the storage section 20 to the storage resource acquiring request from the controller within the same module in the case that the remaining amount of the memory region previously allocated to the self module is short. Further, in this aspect, in order to avoid the matter that the processing speed of the image processing in the image processing section 50 is widely lowered due to the lack of the remaining amount of the memory region being generated in the image processing module 38, it is desirable to set the memory region previously allocated to the image processing module 38 to the sufficiently large size so as to prevent the lack of the remaining amount from being generated in the memory region during the execution of the image processing, and set the memory region previously allocated to the buffer module 40 to the small size having a possibility that the lack of the remaining amount is generated in the memory region during the execution of the image processing, for saving the memory 14.

Further, the description is given above on the assumption that the memory management system by the resource management section 46B is constituted by the management system of securing the memory region allocated to the module in the request source from the memory through the operating system 30 in each case of the request from the individual module of the image processing section 50, however, the structure is not limited to this, but the invention may be applied to a management system of previously securing a fixed size of memory region from the memory 14 through the operating system 30, allocating a partial region of the previously secured memory region if the size of the requested memory region from the individual module is less than a threshold value, and securing the memory region allocated to the request source module through the operating system 30 if the size of the requested memory region is equal to or more than the threshold value.

Further, the description is given above of the aspect that (the programs of) the individual modules constituting the image processing module 50 are executed respectively as the independent threads, at a time of activating the image processing section 50 according to the parallel processing system, however, the structure is not limited to this. Taking into consideration the matter that the image processing or the like in the image processing module 38 is under the state of temporarily stopping at a time when the image processing module reads the image date from the preceding buffer module 40 and writes the image data or the like in the following buffer module 40, the structure may be made such as to separate the program corresponding to the buffer controller of the individual buffer module 40 into a program of the write controller executing the data writing process (FIG. 4), and a program of the following controller executing the data reading process (FIG. 6), execute a program of the image processing module 38, a program of the read controller of the preceding buffer module 40 of the image processing module 38, and a program of the write controller of the following buffer module 40 of the image processing module 38 as a single thread, generate the thread mentioned above with respect to the individual image processing module 38 constituting the image processing section 50, and activate the image processing section 50 according to the parallel processing system by executing in parallel. Further, the program corresponding to the individual module constituting the image processing section may be activated by being executed in parallel to each other by a computing element for a program executing resource (for example, CPU, MMX (multimedia extension), a computing element for SSE (streaming SIMD extension), a high-speed computing element such as DSP (digital signal processor) independently provided from the CPU or the like).

Further, setting and changing the priority of the individual buffer module in correspondence to the execution priority of the program corresponding to the image processing module directly coupled to the individual buffer module may be specifically executed, for example, by coinciding the priority of the individual buffer module with the execution priority of the program corresponding to the image processing module directly coupled to the individual buffer module, or setting the priority corresponding to any one of the average, the maximum and the minimum of the execution priority of the program corresponding to the plural image processing modules in case of being directly connected to the plural image processing modules.

Further, the description is given above by exemplifying the storage section 20 constituted by the HDD, the flash memory or the like as the external storage apparatus according to the invention, however, the structure is not limited to this, but may employ various external storage devices or the like connected to the computer 10 via a communication line. Further, the description is given above by exemplifying the memory 14 constituted by the DRAM, the SRAM or the like as the memory according to the invention, however, the memory according to the invention may employ a storage device that an access speed is relatively higher as compared with the external storage apparatus. For example, in the case that the various external storage devices connected to the computer 10 via the communication line is employed as the external storage apparatus according to the invention, the HDD, the flash memory or the like may be applied as the memory according to the invention.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to are suited to the particular use contemplated. It is intended that the scope of the invention be defined by the following claims and their equivalents.

What is claimed is:

1. An image processing apparatus comprising:
an image processing section having a plurality of modules constituted by a plurality of image processing modules and a buffer module, the plurality of image processing modules acquiring image data from a preceding module thereof, applying a predetermined image processing to the acquired image data, and outputting processed image data or a result of the image processing to a following module thereof, and the buffer module being connected to at least one of a preceding stage or a following stage of the plurality of image processing modules, and being connected according to a pipe line aspect or a directed acyclic graph aspect so as to allow writing of the image data output from the preceding module in a buffer and reading of the image data stored in the buffer by the following module; and
a storage resource management unit that determines whether or not a capacity of a storage resource necessary for allocation is equal to or less than a remaining amount of a securable memory when a module needs to be allocated with the storage resource, or secures the memory and allocates the secured memory as the storage resource to the module that needs to be allocated with the storage resource when the capacity of the storage resource necessary for allocation is equal to or less than the remaining amount, or secures a storage region of an external storage apparatus so as to allocate the secured storage region of the external storage apparatus as the storage resource to the module that needs to be allocated with the storage resource, or secures the storage region of the external storage apparatus so as to write data written in a memory which has already been allocated to another module as the storage resource in the secured storage region of the external storage apparatus and allocate the storage region of the external storage apparatus in which the data is written to the other module in place of the memory in which the data had been written and allocates the memory which had been allocated to the other module as the storage resource to the module that needs to be allocated with the storage resource, when the capacity of the storage resource necessary for allocation is larger than the remaining amount.

2. An image processing apparatus of claim 1, wherein the storage resource management unit allocates a fixed allocation of the memory in advance as the storage resource necessary for each of the image processing modules, or secures the memory in advance for each of the image processing modules and allocates the memory as the storage resource when the image processing module requires the storage resource.

3. An image processing apparatus of claim 1, wherein the storage resource management unit is provided in respective buffer modules, determines whether or not the capacity of the storage resource necessary for allocation is equal to or less than a remaining amount of the securable memory when the buffer module requires allocation of the storage resource, secures the memory and allocates the secured memory as the storage resource to the buffer module when the capacity of the storage resource necessary for allocation is equal to or less than the remaining amount, or secures the storage region of the external storage apparatus and allocates the secured storage region of the external storage apparatus as the storage resource to the buffer module when the capacity of the storage resource necessary for allocation is larger than the remaining amount.

4. An image processing apparatus of claim 1, wherein the modules are activated in parallel to each other.

5. An image processing apparatus of claim 2, wherein the memory has a fixed amount and is allocated in advance to respective buffer modules, the storage resource management unit determines whether or not the capacity of the storage resource necessary for allocation is equal to or less than a remaining amount of the memory allocated in advance to the buffer module when the buffer module needs to be allocated with the storage resource, allocates the memory allocated in advance as the storage resource to the buffer module when the capacity of the storage resource necessary for allocation is equal to or less than the remaining amount, or secures the storage region of the external storage apparatus and allocates the secured storage region of the external storage apparatus as the storage resource to the buffer module when the capacity of the storage resource necessary for allocation is larger than the remaining amount.

6. An image processing apparatus of claim 2, wherein the storage resource management unit monitors release of the memory by a first buffer module which has been allocated with the memory as the storage resource and, when release of the memory is detected, writes data written in the storage region of the external storage apparatus which has already been allocated as the storage resource to a second buffer module in the released memory, and allocates the memory in which the data is written in place of the storage region of the external storage apparatus in which the data had been written, to the second buffer module that had been already allocated with the storage region of the external storage apparatus as the storage resource.

7. An image processing apparatus of claim 6, wherein when there are a plurality of second buffer modules to which the storage region of the external storage apparatus has been already allocated as the storage resource, the storage resource management unit selects a second buffer module to which the memory is allocated in place of the storage region of the external storage apparatus in earliest chronological order with respect to a time when the storage region of the external storage apparatus was allocated as the storage resource.

8. An image processing apparatus of claim 6, wherein a priority is set to each of the buffer modules, and when there are a plurality of second buffer modules to which the storage region of the external storage apparatus has been already allocated as the storage resource, the storage resource management unit selects a second buffer module to which the memory is allocated in place of the storage region of the external storage apparatus in a descending order of the priority.

9. An image processing apparatus of claim 8, wherein the image processing section is actuated by programs corresponding to the respective modules, the programs being executed in parallel to each other by a program execution resource, and further comprises an execution priority controller that executes an initial setting of an execution priority of each of the programs corresponding to the respective image processing modules in correspondence to a position in the connection aspect of the pipe line aspect or the directed acyclic graph aspect of the image processing module, changes the execution priority of each of the programs corresponding to the respective image processing modules in correspondence to a progress degree of the image processing in the image processing section, and sets and changes the execution priority of each of the buffer modules in correspondence to the execution priority of the program corresponding to the image processing module directly connected to each of the buffer modules.

10. A computer readable medium storing a program for causing a computer with a memory and an external storage apparatus to execute an image processing, the processing comprising:
connecting modules constituted by a plurality of image processing modules and a buffer module according to a pipe line aspect or a directed acyclic graph aspect such that the plurality of image processing modules acquire image data from a preceding module thereof, apply a predetermined image processing to the acquired image data, and output the processed image data or a result of the image processing to a following module thereof, and the buffer module is connected to at least one of the preceding stage or the following stage of the plurality of image processing modules so as to allow writing of the image data output from the preceding module in a buffer and reading of the image data stored in the buffer by the following module;
determining whether or not a capacity of a storage resource necessary to be allocated is equal to or less than a remaining amount of a securable memory when a module needs to be allocated with the storage resource; and
when the capacity of the storage resource necessary for allocation is equal to or less than the remaining amount, securing the memory and allocating the secured memory as the storage resource to the module that needs to be allocated with the storage resource, or, when the capacity of the storage resource necessary for allocation is larger than the remaining amount, securing a storage region of an external storage apparatus so as to allocate the secured storage region of the external storage apparatus as the storage resource to the module that needs to be allocated with the storage resource, or securing the storage region of the external storage apparatus so as to write data written in a memory which has been already allocated to another module as the storage resource in the secured storage region of the external storage apparatus and allocate the storage region of the external storage apparatus in which data is written to the other module in place of the memory in which the data had been written and allocating the memory which had been allocated to the other module as the storage resource to the module that needs to be allocated with the storage resource.

11. A computer readable medium of claim 10, wherein the allocating further comprises allocating a fixed allocation of the memory in advance as the storage resource necessary for each of the image processing modules, or securing in advance the memory for each of the image processing modules and allocating the memory as the storage resource when the image processing module requires the storage resource.

12. A computer readable medium of claim 10, wherein the determining further comprises determining whether or not the capacity of the storage resource necessary for allocation is equal to or less than the remaining amount of the securable memory when respective buffer modules require allocation of the storage resource, and the allocating further comprises securing the memory and allocating the secured memory as the storage resource to the buffer module when the capacity of the storage resource necessary for allocation is equal to or less than the remaining amount, or securing the storage region of the external storage apparatus and allocating the storage region of the secured external storage apparatus as the storage resource to the buffer module when the capacity of the storage resource necessary to be allocated is larger than the remaining capacity.

13. A computer readable medium of claim 10, wherein the modules are activated in parallel to each other.

14. A computer readable medium of claim 11, wherein the memory has a fixed amount and is allocated in advance to respective buffer modules, the determining further comprises determining whether or not the capacity of the storage resource necessary for allocation is equal to or less than the remaining amount of the memory allocated in advance to the buffer module that needs to be allocated with the storage resource when the buffer module needs to be allocated the storage resource, and the allocating further comprises allocating the memory allocated in advance as the storage resource to the buffer module when the capacity of the storage resource necessary to be allocated is equal to or less than the remaining amount, or securing the storage region of the external storage apparatus and allocating the secured storage region of the external storage apparatus as the storage resource to the buffer module when the capacity of the storage resource necessary to be allocated is larger than the remaining amount.

15. A computer readable medium of claim 11, wherein the allocating further comprises monitoring release of the memory by a first buffer module which has been allocated with the memory as the storage resource and, when release of the memory is detected, writing the data written in the storage region of the external storage apparatus which has been already allocated to a second buffer module as the storage resource in the released memory, and allocating the memory in which the data is written in place of the storage region of the external storage apparatus in which the data had been written, to the second buffer module to which the storage region of the external storage apparatus had been already allocated as the storage resource.

16. A computer readable medium of claim 15, wherein when there are a plurality of second buffer modules to which the storage region of the external storage apparatus has been already allocated as the storage resource, the allocating further comprises selecting a second buffer module to which the memory is allocated in place of the storage region of the external storage apparatus, in earliest chronological order with respect a time when the second buffer modules are allocated with the storage region of the external storage apparatus as the storage resource.

17. A computer readable medium of claim 15, wherein when there are a plurality of second buffer modules to which the storage region of the external storage apparatus has been already allocated as the storage resource, a priority is set to each of the buffer modules, and the allocating further comprises selecting a second buffer module which is allocated with the memory in place of the storage region of the external storage apparatus in a descending order of the priority.

18. A computer readable medium of claim 17, wherein the image processing section is actuated by programs corresponding to the respective modules, the programs being executed in parallel to each other by a program execution resource, and further comprising executing an initial setting of an execution priority of each of the programs corresponding to the respective image processing modules in correspondence to a position in the connection aspect of the pipe line aspect or the directed acyclic graph aspect of the image processing module, changing the execution priority of each of the programs corresponding to the respective image processing modules in correspondence to a progress degree of the image processing, and setting and changing the execution priority of each of the buffer modules in correspondence to the execution priority of the program corresponding to the image processing module directly coupled to each of the buffer modules.

19. A computer data signal embodied in a carrier wave for enabling a computer with a memory and an external storage apparatus to execute an image processing, the processing comprising:
connecting modules constituted by a plurality of image processing modules and a buffer module according to a pipe line aspect or a directed acyclic graph aspect such that the plurality of image processing modules acquire image data from a preceding module thereof, apply a predetermined image processing to the acquired image data, and output processed image data or a result of the image processing to a following module thereof, and a buffer module is coupled to at least one of a preceding stage or a following stage of the plurality of image processing modules so as to allow writing of the image data output from the preceding module in a buffer and reading of the image data stored in the buffer by the following module;
determining whether or not a capacity of a storage resource necessary for allocation is equal to or less than a remaining amount of a securable memory when a module needs to be allocated with the storage resource; and
when the capacity of the storage resource necessary for allocation is equal to or less than the remaining amount, securing the memory and allocating the secured memory as the storage resource to the module that needs to be allocated with the storage resource, or, when the capacity of the storage resource necessary for allocation is larger than the remaining amount, securing a storage region of an external storage apparatus so as to allocate the secured storage region of the external storage apparatus as the storage resource to the module that needs to be allocated with the storage resource, or securing the storage region of the external storage apparatus so as to write data written in a memory which has been already allocated to another module as the storage resource in the secured storage region of the external storage apparatus and allocate the storage region of the external storage apparatus in which data is written to the other module in place of the memory in which the data had been written and allocating the memory which had been allocated to the other module as the storage resource to the module that needs to be allocated with the storage resource.
